(19) United States
(12) Patent Application Publication
(10) Pub. No.: US 2004/0117858 A1
(43) Pub. Date: Jun. 17, 2004

(54) Data enhanced multi-media system for an external device

(76) Inventors: Paul A. Boudreau, Marietta, GA (US); Samuel H. Russ, Lawrenceville, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/318,116

(22) Filed: Dec. 12, 2002

(51) Int. Cl. H04N 7/16; H04N 7/173

(52) U.S. Cl. 725/144; 725/133; 725/153

(57) ABSTRACT

An apparatus provides multimedia content by receiving first content from a client device, the first content encoded in a digital stream, decoding the digital stream to produce decoded first content, and presenting the decoded first content in addition to the presentation of second content presented at a display device.

### TECHNICAL FIELD

This invention relates in general to the field of television systems, and more particularly, to the field of interactive television.

### BACKGROUND OF THE INVENTION

With recent advances in digital transmission technology, subscriber television systems are now capable of providing much more than the traditional analog broadcast video. In implementing enhanced programming, the home communication terminal (“HCT”), otherwise known as the set-top box, has become an important computing device for accessing content services (and content within those services) and navigating a user through a maze of available services. In addition to supporting traditional analog broadcast video functionality, digital HCTs (or “DHCTs”) now also support an increasing number of two-way digital services such as video-on-demand and personal video recording.

Typically, a DHCT is connected to a cable or satellite, or generally, a subscriber television system, and includes hardware and software necessary to provide the functionality of the digital television system at the user's site. Some of the software executed by a DHCT can be downloaded and/or updated via the subscriber television system. Each DHCT also typically includes a processor, communication components, and memory, and is connected to a television or other display device, such as a personal computer. While many conventional DHCTs are stand-alone devices that are externally connected to a television, a DHCT and/or its functionality may be integrated into a television or personal computer or even an audio device such as a programmable radio, as will be appreciated by those of ordinary skill in the art.

While subscriber television systems offer a variety of services, there remains a vast potential of untapped markets where the resources of the subscriber television system can be effectively employed. For example, visual media and merchandising have enjoyed a long history of effective and synergistic business promotion and increasing sales. Television shows and movies provide licensing opportunities for toy manufacturers to sell merchandise. These sales are made directly through distributors or through third parties such as fast food chains that offer licensed merchandise and open new sources of revenue for retailers, cable operators, media production, and set-top box manufacturers. What is needed is a system that taps into this vast merchandising market using subscriber television technology.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram depicting a non-limiting example of a subscriber television system (STS), in accordance with one embodiment of the invention.

FIGS. 2A-2B are schematics of example implementations of a multi-media system implemented in the subscriber television system shown in FIG. 1, in accordance with one embodiment of the invention.

FIGS. 3-4 are schematics of example implementations of a multi-media system implemented in the subscriber television system shown in FIG. 1, in accordance with one embodiment of the invention.

FIG. 5 is a block diagram depicting a non-limiting example of selected components of the headend as depicted in FIG. 1, in accordance with one embodiment of the invention.

FIG. 6A is a block diagram that illustrates the mapping of a Motion Pictures Expert Group (MPEG) elementary stream into an MPEG application stream, in accordance with one embodiment of the invention.

FIG. 6B is a block diagram of an exploded view of some of the content carried in the MPEG application stream depicted in FIG. 6A, in accordance with one embodiment of the invention.

FIG. 7A is a block diagram illustration of an example digital home communication terminal (DHCT) as depicted in FIG. 1, which is coupled to a headend, a television, and an external device, in accordance with one embodiment of the invention.

FIG. 7B is a block diagram of example external device circuitry of the external device shown in FIG. 7A, in accordance with one embodiment of the invention.

FIG. 8 is a timing diagram of one example implementation for detecting an external device and downloading content to the external device, in accordance with one embodiment of the invention.

### DETAILED DESCRIPTION OF THE PREFERRED EMBODIMENTS

The preferred embodiments of the invention now will be described more fully hereinafter with reference to the accompanying drawings. The preferred embodiments of the invention include a multi-media system that coordinates the presentation of content in one device with the presentation of the same or related content in one or more other devices. The multimedia system can be implemented in many systems, but will be described in the context of a subscriber television system. The multi-media system includes functionality that provides for the download of content (including video, audio, and/or data corresponding to television show episodes, movies, etc.) that is related to the content (e.g., programming) presented on a television, and its corresponding presentation at an external device. Herein such content that is related (e.g., relatedness as to subject matter, message, theme, etc.) to programming presented on a television and is for download (or transmittal) to an external device will be referred to as related content. The related content can be transferred to the external device through a medium (e.g., cable or wiring) that physically connects a digital home communication terminal (DHCT) to the external device, or through air via radio frequency (RF) transmission and/or infrared (IR) transmission, among other mechanisms. Note that in other embodiments, the content can be unrelated content, such as external device software upgrades to improve interactivity to the multi-media system, among other unrelated content.

The presentation of content displayed on the television set can be synchronized with the related content presentation at the external device. For example, the external device can be embodied in the form of an action figure corresponding to a like character on a television show. The action figure can include functionality for providing audio related to the show. In one implementation, whenever the character on the television show speaks during a particular episode, his or her voice is heard emanating from the action figure associated with the character, alone or in conjunction with the sound (i.e., the character's voice) emanating from the television set.

In other implementations, the theme of the show (for example, “say no to drugs”) can be reinforced in the user through the action figure in a non-synchronized, or partially synchronized manner (partially synchronized in the sense that the related content is presented sometime during the scheduled presentation for the content shown on the television set). For example, an action figure (or doll, among other devices) can include downloaded audio clips of phrases such as “don't do drugs” or “stay away from drug users,” the verbatim phrases which may or may not have been presented during the television episode. This related content can be downloaded to the action figure at the start of, in advance of, during, and/or after the particular episode that presents this anti-drug theme. The audio clips can then be presented for playback through the action figure during the show, later on in the day, and/or until that content is overwritten with new content from another episode, among other examples, thus providing increased show awareness to the user and reinforcing positive messages.

An example subscriber television system is described initially, followed by some example implementations using the example subscriber television system to provide an infrastructure for the multimedia system functionality. Following the example implementations is a description of an example headend and example mechanisms that can be employed by the headend for sending content to a DHCT for presentation on a television set and for downloading related content to an external device. Then, an example DHCT and example external device circuitry for an external device are described. Finally, one example implementation for detecting an external device and downloading related content to the external device is described, in accordance with one embodiment of the invention.

The invention may, however, be embodied in many different forms and should not be construed as limited to the embodiments set forth herein; rather, these embodiments are provided so that this disclosure will be thorough and complete, and will fully convey the scope of the invention to those of ordinary skill in the art. Furthermore, all “examples” given herein are intended to be non-limiting and among others not shown but understood to be within the scope of the invention.

### Example Subscriber Television System

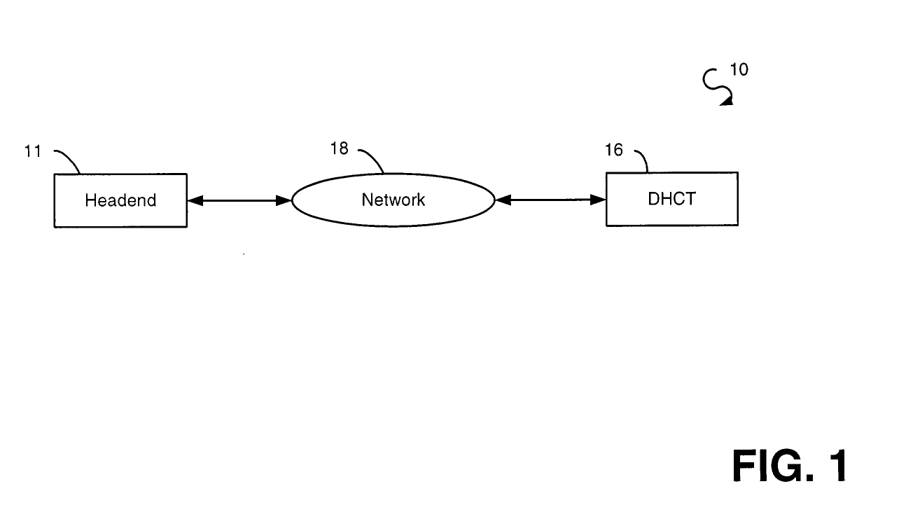

FIG. 1 is a block diagram depicting a non-limiting example of a subscriber television system (STS) 10. In this example, the STS 10 includes a headend 11 and a digital home communication terminal (DHCT) 16 that are coupled via a communications network 18. It will be understood that the STS 10 shown in FIG. 1 is merely illustrative and should not be construed as implying any limitations upon the scope of the preferred embodiments of the invention. For example, although single components (e.g., a headend and a DHCT) are illustrated in FIG. 1, the STS 10 can feature a plurality of any one of the illustrated components, or may be configured with alternative embodiments for any one of the individual components or with yet other additional components not enumerated above. Subscriber television systems also included within the scope of the preferred embodiments of the invention include systems not utilizing physical structured cabling for transmission, such as, but not limited to, satellite systems and terrestrial-broadcast systems (such as Multichannel Multipoint Distribution Service (MMDS) and local TV stations).

A DHCT 16 is typically situated at the residence or place of business or recreation of a user and may be a stand-alone unit or integrated into another device such as, for example, a television set or a personal computer or other display devices, or an audio device, among other client devices. The DHCT 16 receives content (video, audio and/or other data) from the headend 11 through the network 18 and in some embodiments, provide reverse information to the headend 11 through the network 18.

The headend 11 receives content from one or more content providers (not shown), including local providers. The content is processed and/or stored and then transmitted to client devices such as the DHCT 16 via the network 18. The headend 11 may include one or more server devices (not shown) for providing content to the DHCT 16. The headend 11 and the DHCT 16 cooperate to provide a user with television services via a television set (not shown). The television services may include, for example, broadcast television services, cable television services, premium television services, video-on-demand (VOD) services, and/or pay-per-view (PPV) services, among others.

### Example Multimedia System Implementations

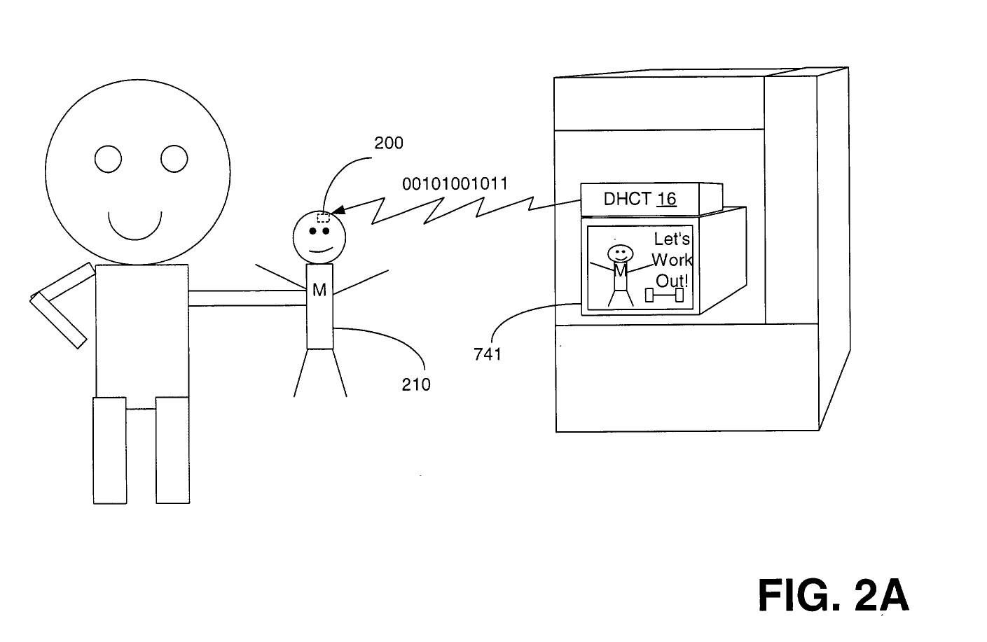

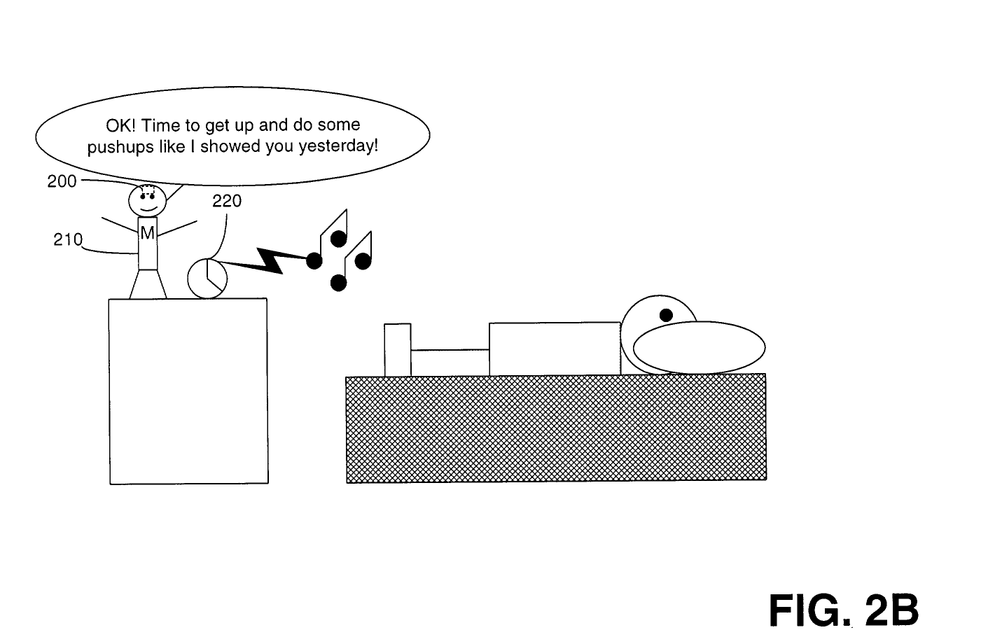

FIGS. 2A-4 are schematic diagrams illustrating some example recreational and educational TV implementations for the multi-media system as used in the example subscriber television system 10 (FIG. 1), in accordance with one embodiment of the invention. The multimedia system enables television show producers to license (and toy manufacturers to offer) merchandise that can adapt to and reflect the content of the television production. The multimedia system can be used to continue the learning experience of a child throughout the day, and increase the level of interest in the show, since the child relates the show with both the viewing image and the interactive programming of a toy. The multi-media system in the example implementation shown in FIG. 2A includes an external device embodied as a doll 210 (which includes external device circuitry 200, preferably located internal to the doll 210), a DHCT 16, and a television set 741. In the example implementation shown, a child workout show is presented. The doll 210 the child is holding is made to the likeness of the host.

The external device circuitry 200 (hardware and/or software) incorporated into the doll 210 receives content (as represented by the zigzag line that is digitally modulated, as represented by the 0 and 1's) from the DHCT 16. In the example implementation shown, the downloaded content is related to the child workout show, and includes the audio content representing the encoded voice signals of the host of this child workout show. The show host barks out, “Let's work out”, and this audio is heard emanating from the television set 741 (or from remote speakers for the television set 741) and from the doll 210 (or from only the doll 210). The doll 210 preferably receives this audio content in real-time with the show presentation, but in other embodiments, the audio content can be downloaded to the doll 210 ahead of time and presented in synchronization with the corresponding video for the show when “awakened” by trigger signals sent by the DHCT 16 or according to time stamps interpreted by the DHCT 16 and downloaded to the external device circuitry 200 (or interpreted at the doll 210). For example, the doll 210 can be equipped with a clock or other timer (not shown) which operates in synchronization with the DHCT 16 using normal play time (NPT) mechanisms, enabling the data stream to reference the internal clock of the doll 210 since it is in synchronization with the DHCT clock (not shown).

In other embodiments, the related content downloaded to the doll 210 can include audio clips that may or may not be the verbatim audio used in the television show episode presented on the television set 741. That is, the audio of the doll 210 does not necessarily have to be synchronized to the presentation of the show, nor does the audio presented through the doll 210 have to ever be heard emanating from the TV presentation (i.e., the voice from the doll 210 does not have to be the exact dialogue spoken by the host of the child workout show). For example, content related to the show, such as key words that mirror the theme of the last tuned show (e.g., “stay fit”) can be programmed by the content provider and sent in an associated elementary stream for that show. This related content can be downloaded to the external device circuitry 200 of the doll 210 at anytime before, during, and/or after the show presentation, and presented to the child at the press of a button (not shown) on the doll 210, after an elapsed time as configured by an internal timer (not shown) in the doll 210, and/or in response to certain environmental stimuli like light, sound, etc., via sensors (not shown) included in the doll 210, among other mechanisms.

For example, as shown in the schematic of FIG. 2B, upon the alarm 220 activating and emitting a buzzer sound or music (represented by the music notes), the doll 210 begins to speak about something related to the prior show (e.g., the workout show) using audio content downloaded to the doll 210 contemporaneously with the presentation of the prior show. In this example, the doll 210 urges the child, “OK. Time to get up and do some pushups like I showed you yesterday!” In other embodiments, the downloaded content can include embedded instructions for the external device circuitry 200 that, when executed, cause the doll 210 (via internal actuators not shown) to begin doing sit-ups, or other physical acts at any particular time after a timed interval and/or in response to external stimuli. Conversely, the child's stimulus, such as pressing a button, could evoke a pre-downloaded response. Note that both embodiments shown in FIGS. 2A and 2B can be implemented in the same doll 210 or different dolls. For example, each function described for these embodiments can be implemented through separately purchasable plug and play modules that interface with the external device circuitry 200 (and thus are implemented in the same doll). As another example, there can be a doll for reinforcing the content or content theme (e.g., stay healthy) and a different doll for speaking the dialogue presented during the show in real-time, or these different functions can be achieved separately or combined through replaceable or programmable electronic chips or software modules.

The above described functionality can be extended to handheld games, among other devices. For example, interactive features can be added to current TV programming, the content of which is mirrored in hand-held games, as one example. The functions of updating character functionality or adding additional characters can be achieved based on the user interaction with a particular episode. For example, new secondary characters can be included in the related content, which are added to the games while viewing a particular episode (e.g., as opposed to buying a new cartridge). In addition, new methods can be downloaded to the games and the clues to using these methods can be found (and/or downloaded) only by watching that particular episode. Further, games can be controlled by the multi-media system based on synchronization signals with the episode (via the DHCT 16). As another example, preprogrammed game sequences can be enabled during the television media broadcast.

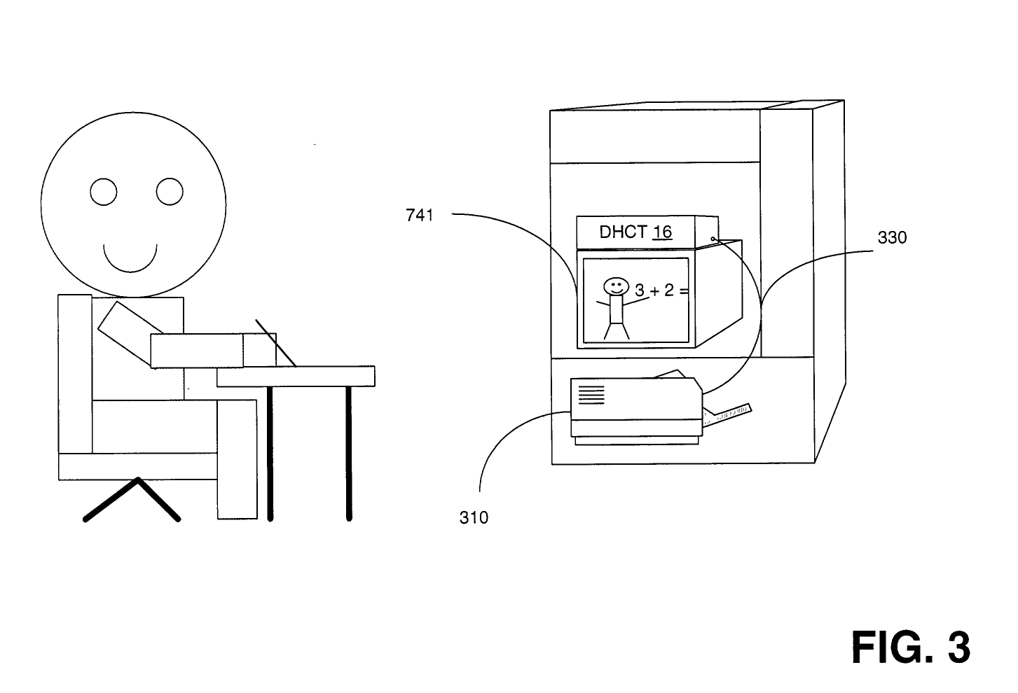

FIG. 3 depicts a home schooling and/or remote schooling implementation, in accordance with one embodiment of the invention. In the example implementation depicted in FIG. 3, a child is shown at his desk taking notes and/or following instructions during an educational show presented on the television set 741. The example show is a tutorial on basic math principles. In this example, a printer 310 is physically connected (with communication over a wiring medium 330) to the DHCT 16 via the communication port of the DHCT 16, and during the tutorial, the related content includes homework and/or practice sheets that are downloaded to the printer 310. Extensions to this implementation include national or regional bible studies, or continuing education, among others. The external device could also include such devices that augment the program for physically disabled persons.

Other embodiments can include bi-directional communication between the various types of external devices and the DHCT 16 to provide feedback to the DHCT 16 (and subsequently to the content provider) to help tailor the content to be downloaded to external devices, or to be passed on to the program provider for purposes such as grading tests and ordering merchandise, among other tasks. For example, a user can use a remote control device that enables, in cooperation with the DHCT 16, user input capability. The remote control device could be a mouse, keyboard, touchscreen, infrared (IR) remote, personal computer (PC), laptop, or a scanner, among others or a combination of these. For instance, a scanner could be hooked to a PC to perform optical character recognition (OCR) (or to perform functionality equivalent to a bubble-in/OPSCAN form) of test answers formulated by a user. The signals corresponding to the remote control input are received by the DHCT 16 and sent upstream (e.g., to the program provider) for grading and other related or unrelated tasks.

The multimedia system can provide the opportunity for a wide array of television productions that include, as one example, 30 minutes of visual content backed by portable products that extend the learning process beyond the scope of the show. These devices can provide an interactive learning process for the user beyond a typical 30-minute audio-visual show. External devices can range from simple “speak and spell” devices that aid in the learning of words, language, and/or grammar in multiple languages at all learning levels to “learn and test” devices that provide basic scientific measurement results. The “learn and test” devices can include simple temperature and force measuring devices and a simple flat panel screen. A television show can describe simple experiments while the “learn and test” device is loading experimental notes and prompts that will guide the user through learning experiences that are carried out after the show. This active link between the television show episode and the “learn and test” device provides for formats of the shows and device user interfaces that can be adapted to suit a wide variety of learning experiences.

The multi-media system can also provide for extended content to day-care centers that are typically struggling to provide new activities for children. The interactive use of the learning devices likely won't carry the stigma of excessive “TV watching”, and can provide an extra activity beyond the 30-minute educational show, and can allow children to work on individual schedules.

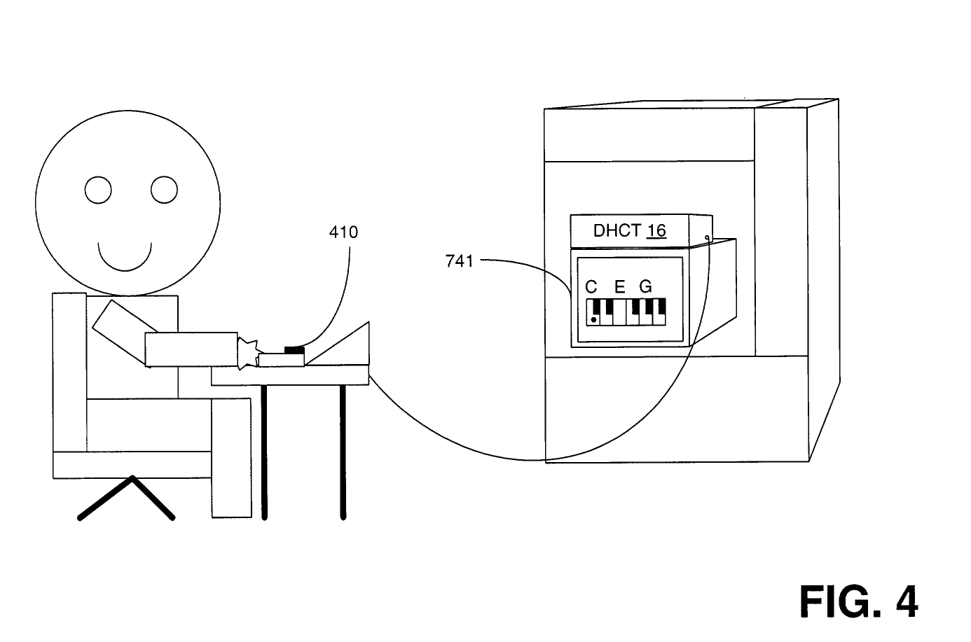

FIG. 4 is a schematic of another example implementation, demonstrating how the multi-media system can provide tutorials in music education, in accordance with one embodiment of the invention. A music piece can be presented on the television set 741 using one or more instruments (and even played using an orchestra). The aspect of the music piece the user is interested in playing is then presented on the television set 741. In this example, the user has indicated an interest in the piano part, and thus a keyboard is displayed on the television 741 with notes above the keys and a moving “dot” or other symbol corresponding to the current note that is to be played on the piano 410 (connected to the DHCT 16) by the user according to the presented song. For example, the “dot” on the keyboard displayed on the television screen may not move until it receives feedback (via a bi-directional port at the DHCT 16, for example) indicating that the user has struck the proper key on his or her piano 410. The number and sizes of lessons to be downloaded to the DHCT 16 can be variable, based on the current level of interest and current skill level, and thus need not consume considerable amounts of memory.

### Example Headend

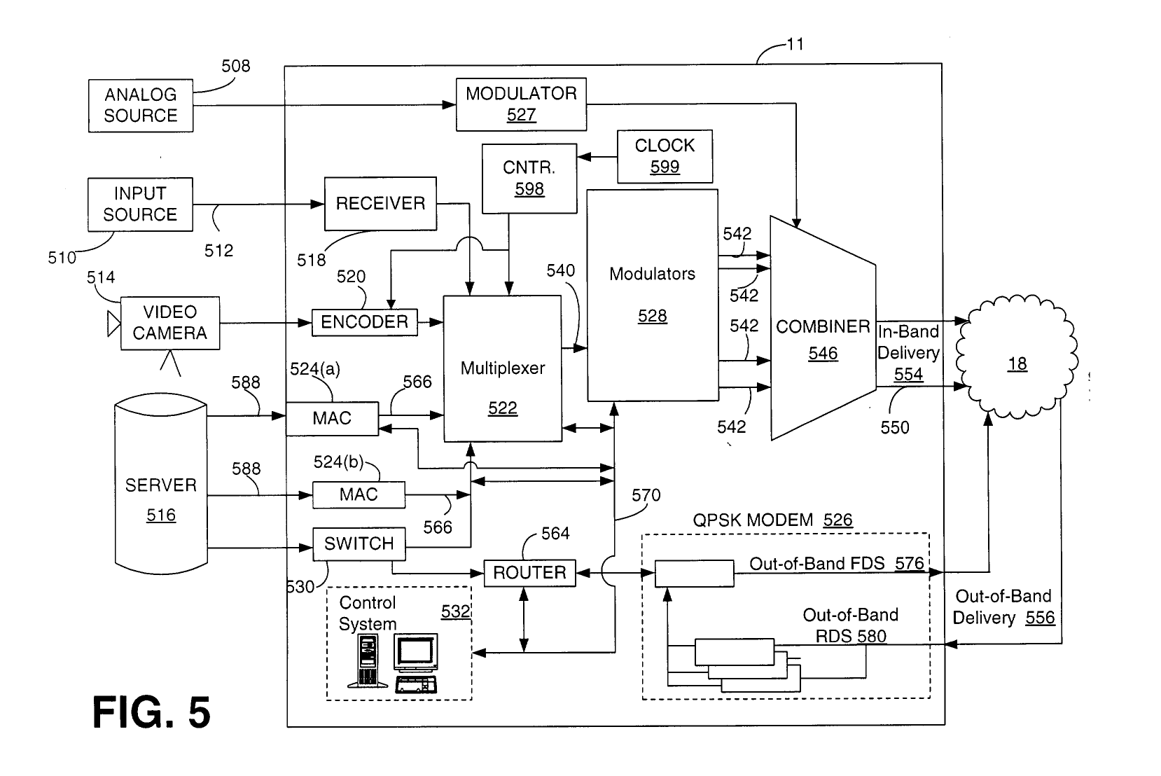

Since the example implementations illustrated in FIGS. 2A-4 were described in the context of an example subscriber television system, the relevant components of the subscriber television system will now be described as one example infrastructure for providing the functionality of the multimedia system described above. FIG. 5 is an overview of an example headend 11, which provides the interface between the STS 10 (FIG. 1) and the service and content providers. The overview of FIG. 5 is equally applicable to an example hub (not shown), and the same elements and principles may be implemented at a hub instead of the headend 11 as described herein. It will be understood that the headend 11 shown in FIG. 5 is merely illustrative and should not be construed as implying any limitations upon the scope of the preferred embodiments of the invention. The headend 11 receives content from a variety of service and content providers, which can provide input in a variety of ways. The headend 11 combines the content from the various sources and distributes the content to subscribers via the distribution systems of the network 18.

In a typical system, the programming, services and other information from content providers can be distributed according to a variety of mechanisms. The input signals may be transmitted from sources to the headend 11 via a variety of transmission paths, including satellites (not shown) and terrestrial broadcast transmitters and antennas (not shown). The headend 11 can also receive content from a direct feed source 510 via a direct line 512. Other input sources from content providers include a video camera 514, analog input source 508, or an application server 516. The application server 516 may include more than one line of communication. One or more components such as the analog input source 508, input source 510, video camera 514, and application server 516 can be located external to the headend 11, as shown, or internal to the headend 11 as would be understood by one having ordinary skill in the art. The signals provided by the content or programming input sources can include a single content instance or a multiplex that includes several content instances.

The headend 11 generally includes one or more receivers 518 that are each associated with a content source. MPEG (Motion Pictures Expert Group) encoders, such as encoder 520, are included for digitally encoding local programming or a real-time feed from the video camera 514, or the like. An MPEG encoder such as the encoder 520 receives content such as video and audio signals and converts the content into digitized streams of content known as elementary streams. The encoder produces separate elementary streams for the video content and the audio content. In many instances, an MPEG program, such as a movie, includes a video elementary stream, audio elementary streams in multiple different languages, and associated elementary streams, which include things such as the director's comments, out takes, etc., or whatever the producer or distributor or others desire to associate with the movie, such as related content to download to an external device. In other embodiments, the related content can be embedded in the same packet identifiers (PIDs) used for the content to be presented on the television set (not shown).

In one implementation, a multiplexer 522 is fed with a counter 598, which in turn is fed by an encoder clock 599 preferably driven at a defined frequency, for example 27 megahertz (MHz), using a phase locked loop clocking mechanism as is well known to those skilled in the art. The encoder clock 599 drives the counter 598 up to a maximum counter value before overflowing and beginning again. The multiplexer 522 will periodically sample the counter 598 and place the state of the count in an extended packet header as a program clock reference (PCR). Transport streams (a multiplex of several program streams) are synchronized using PCRs, and program streams are synchronized using system clock references (SCRs), which also are samples of the counter 598, typically at greater intervals than the PCRs. The PCRs and SCRs are used to synchronize the decoder clock (not shown) at the DHCT 16 (FIG. 1) with the encoder clock 599. Further, the encoder 520 is also fed by the counter 598 at the occurrence of an input video picture and/or audio block at the input to the encoder 520. The value of the counter 598 is preferably added with a constant value representing the sum of buffer delays at the headend 11 and the DHCT 16, creating a presentation time stamp (PTS), which is inserted in the first of the packets representing the picture and/or audio block. Decode time stamps (DTS) can also be driven by the counter 598 and input to the encoder 520, and represent the time at which data should be taken from a decoder buffer (not shown) at the DHCT 16 and decoded. Note that it will be understood by those having ordinary skill in the art that additional components, such as registers, phase lock loops, oscillators, etc. can be employed to achieve the timing/synchronization mechanisms herein described. Further information on the synchronization mechanisms of MPEG can be found in MPEG standard ISO/IEC 13818-1, herein incorporated by reference.

The analog input source 508 can provide an analog audio/video broadcast signal that can be input into a modulator 527. From the modulator 527, a modulated analog output signal can be combined at a combiner 546 along with other modulated signals for transmission in a transmission medium 550. Alternatively, analog audio/video broadcast signals from the analog input source 508 can be input into a modulator 528. Alternatively, analog audio/video broadcast signals can be input directly from the modulator 527 to the transmission medium 550. The analog broadcast content instances are transmitted via respective RF channels, each assigned for transmission of an analog audio/video signal such as National Television Standards Committee (NTSC) video.

A switch, such as an asynchronous transfer mode (ATM) switch 530, provides an interface to an application server 516. There can be multiple application servers 516 providing a variety of services such as a Pay-Per-View service, including video on demand (VOD), a data service, an Internet service, a network system, or a telephone system. Service and content providers may download content to an application server located within the STS 10 (FIG. 1). The application server 516 may be located within the headend 11 or elsewhere within the STS 10, such as in a hub. The various inputs into the headend 11 are then combined with the other information from a control system 532, which is specific to the STS 10, such as local programming and control information, which can include, among other things, conditional access information. As indicated above, the headend 11 contains one or more modulators 528 to convert the received transport streams 540 into modulated output signals suitable for transmission over the transmission medium 550 through the network 18. Each modulator 528 may be a multimodulator including a plurality of modulators, such as, but not limited to, quadrature amplitude modulation (QAM) modulators, that radio frequency modulate at least a portion of the transport streams 540 to become output transport streams 542. The output transport streams 542 from the various modulators 528 or multimodulators are combined, using equipment such as the combiner 546, for input to the transmission medium 550, which is sent via the in-band delivery path 554 to subscriber locations (not shown). The in-band delivery path 554 can include various digital transmission signals and analog transmission signals.

In one embodiment, the application server 516 also provides various types of data 588 to the headend 11. The data is received, in part, by the media access control functions 524 (e.g., 524a and 524b) that output MPEG transport packets containing data 566 instead of digital audio/video MPEG streams. The control system 532 enables the television system operator to control and monitor the functions and performance of the STS 10 (FIG. 1). The control system 532 interfaces with various components, via communication link 570, in order to monitor and/or control a variety of functions, including the frequency spectrum lineup of the programming for the STS 10, billing for each subscriber, and conditional access for the content distributed to subscribers, among other information. Information, such as conditional access information, is communicated from the control system 532 to the multiplexer 522 where it is multiplexed into the transport stream 540.

Among other things, the control system 532 provides input to the modulator 528 for setting the operating parameters, such as selecting certain content instances or portions of transport streams for inclusion in one or more output transport streams 542, system specific MPEG table packet organization, and/or conditional access information. Control information and other data can be communicated to hubs and DHCTs 16 (FIG. 1) via an in-band delivery path 554 or via an out-of-band delivery path 556.

The out-of-band data is transmitted via the out-of-band forward data signal (FDS) 576 of the transmission medium 550 by mechanisms such as, but not limited to, a QPSK modem array 526. Two-way communication utilizes the return data signal (RDS) 580 of the out-of-band delivery path 556. Hubs and DHCTs 16 (FIG. 1) transmit out-of-band data through the transmission medium 550, and the out-of-band data is received in the headend 11 via the out-of-band RDS 580. The out-of-band data is routed through a router 564 to the application server 516 or to the control system 532. The out-of-band control information includes such information as, among many others, a pay-per-view purchase instruction and a pause viewing command from the subscriber location to a video-on-demand type application server located internally or external to the headend 11, such as application server 516, as well as any other data sent from the DHCT 16 or hubs, all of which will preferably be properly timed. The control system 532 also monitors, controls, and coordinates all communications in the subscriber television system, including video, audio, and data. The control system 532 can be located at the headend 11 or remotely. The transmission medium 550 distributes signals from the headend 11 to the other elements in the subscriber television system, such as a hub, a node (not shown), and subscriber locations (FIG. 1). The transmission medium 550 can incorporate one or more of a variety of media, such as optical fiber, coaxial cable, and hybrid fiber/coax (HFC), satellite, direct broadcast, or other transmission media.

In one implementation, encryption can be applied to the data stream of requested content at the modulators 528 at the headend 11 according to encryption methods well known to those of ordinary skill in the art. An encryption component resident in the modulators 528 in the headend 11, or elsewhere, and under the direction of the control system 523 encrypts, for example, MPEG-2 transport stream packets used to transmit the content. The encrypted content also includes, in one embodiment, entitlement control messages that are recognized by a conditional access processor (not shown) located in the DHCT 16 (FIG. 1) and/or an external device (not shown) as information needed to decrypt the encrypted content. The conditional access processor preferably stores authorization information, wherein the authorization information indicates that the subscriber is entitled to access the content. The authorization information is obtained from one or more entitlement messages sent by the headend 11 after, or concurrently with, initialization of the DHCT 16 into a purchased service. If the authorization information indicates that the subscriber is entitled to the content, the conditional access processor generates a code word or key based on the authorization information and the received entitlement control message, and the conditional access processor uses this key to decrypt the encrypted content at a decrypter (not shown) located at the DHCT 16 and/or an external device.

### MPEG Streams and Synchronization Mechanisms

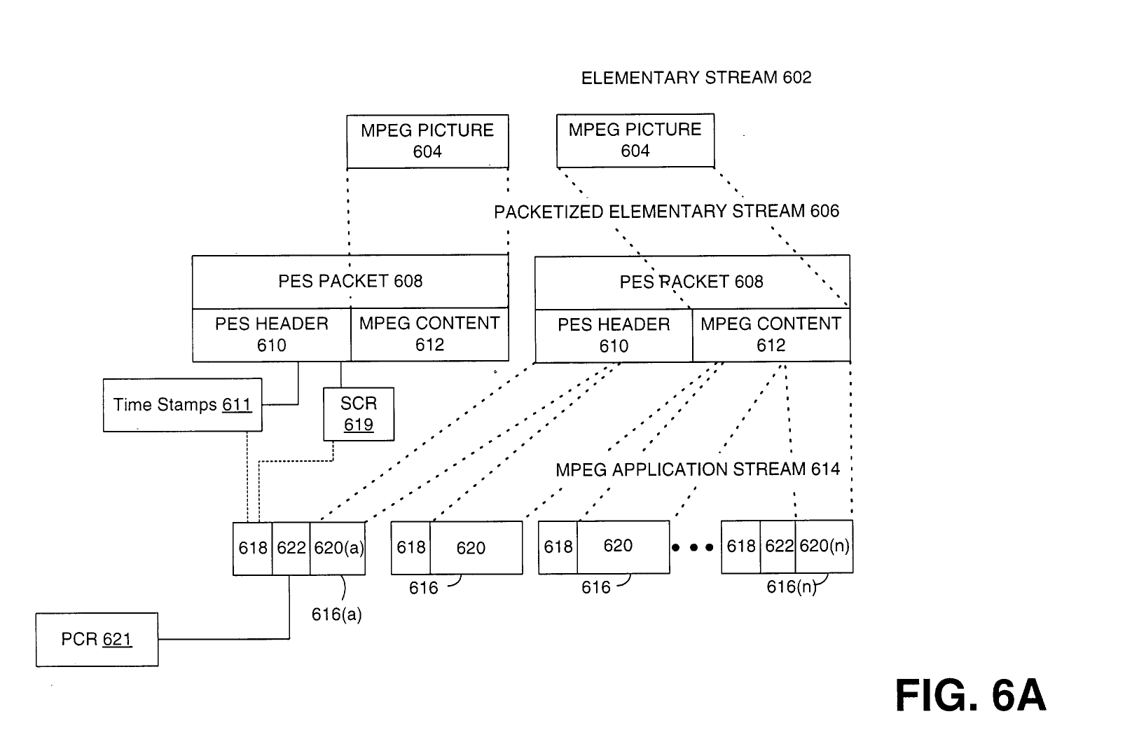

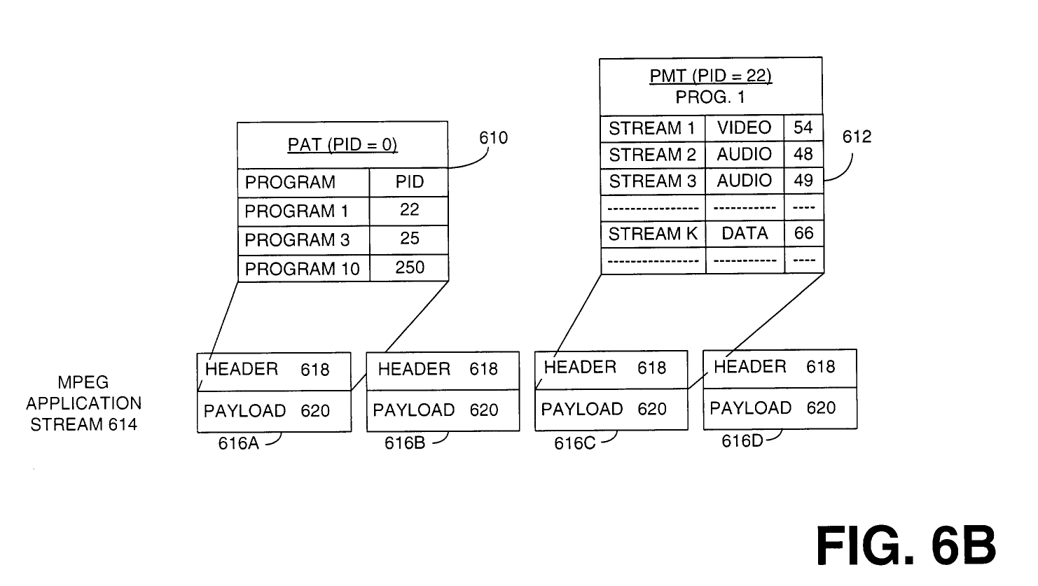

In FIG. 6A the relationship between a video elementary stream and packets that carry the elementary stream to the user is shown. Those skilled in the art will recognize that other elementary streams such as audio elementary streams have similar relationships. For a video elementary stream, the elementary stream 602 is made up of a stream of MPEG pictures 604. Each MPEG picture 604 corresponds to a picture on a television screen in which each pixel of the television screen has been illuminated, and an audio elementary stream (not shown) is made up of multiple audio frames, some of which are synchronized with the MPEG pictures for presentation and some of which are referenced to the MPEG pictures but are not necessarily in synchronization with them (for example those designated for deferred presentation in an external device). The MPEG picture 604 is an example of a frame of information, and for the purposes of this disclosure, a frame of information is defined as a segment of information having a predefined format.

Each elementary stream 602, which is a stream of frames of information, is then converted into a packetized elementary stream (PES) 606, which is made up of PES packets 608. Each PES packet 608 includes a PES header 610 and MPEG content 612. The PES header 610 includes information such as time stamps 611 and System Clock Reference (SCR) codes 619. The time stamps 611 are used for synchronizing the various elementary streams 602. There are two types of time stamps 611, referred to as presentation time stamps (PTS) and decode time stamps (DTS), which are samples of the state of the counter 598 (FIG. 5) driven by the clock 599 (FIG. 5) at the headend 11 (FIG. 5), as described in association with FIG. 5. The PTS determines when the associated picture should be presented on the screen, whereas a DTS determines when it should be decoded. Audio packets typically only have PTSs. For example, if lip synching between the audio content presented in the external device and the corresponding video presented on TV (or between the video and the audio in the presentation on TV) is required, the audio and the video streams of a particular content instance are preferably locked to the same master clock and the time stamps 611 will come from the same counter driven by that clock. For implementations where the related content is to be deferred, the PES header 610, in one embodiment, may be void of time stamps and forwarded to the external device “as-is”. The data payload of the MPEG content 612 can include time stamps that are usable at a higher layer of protocol at an external device to enable deferred presentation (e.g., in the morning in response to an alarm), or also be void of time stamps, which may also be recognized by the external device as not requiring in synchronization presentation.

The MPEG content 612 includes information from the MPEG picture 604. Generally, an MPEG picture 604 is mapped into one PES packet 608, with the MPEG content 612 corresponding to the MPEG picture 604. Because the MPEG picture 604 is of variable bit size, the bit size of the PES packet 608 is also variable. The packetized elementary stream 606 is then mapped into the MPEG application stream 614, which is made up of MPEG application packets 616. MPEG application packets 616 are of fixed size, 188 bytes, and include a header 618, which is 4 bytes in size, a payload 620 and an optional adaptation field 622. The PES packet 608 is mapped into multiple MPEG application packets 616 such that the first byte of the PES header 610 is the first byte of the payload 620(a) and the last byte of the MPEG content 612 is mapped into the last byte of the payload 620(n).

The adaptation field 622 is an expandable field that is used for, among other things, including system time reference markers such as Program clock Reference (PCR) codes 621 and other information that is specific to the STS 10 (FIG. 1). In addition, the adaptation field 622 is used to ensure that the bit size of an MPEG packet 616 is 188 bytes. For example, the adaptation field 622 of MPEG application packet 616(n) is expanded to a particular size so that the last byte of MPEG content 612 is the last byte of payload 620(n).

Typically, the payload 620 of an MPEG packet 616 can be considered to include application content and presentation content. Application content includes general header information such as the PES header 610 and other application information, such as content type (video, audio, etc.), the type of compression algorithm used, and other application information. The presentation content includes data that was encoded into MPEG format such as audio information or a video image.

The header 618 includes a field that is 13 bits in size that is known as a Packet Identifier (PID), which is used to identify the packet as being a packet of a particular elementary stream. For example, all of the packets that carry video information of a program have the same PID value. The header 618 also includes a field that is 4 bits in size that is known as a continuity counter. Typically, the counter is incremented for each MPEG packet 616 with the same PID when the packet 616 includes a payload 620. In other words, if the packet 616 consists of a 4 byte header 618 and an 184 byte adaptation field 622, then the continuity counter is not incremented for that packet. In addition, in some systems redundant packets (i.e., a packet having the same payload 620 as a previously transmitted packet 616) are transmitted, and typically, the continuity counter of the redundant counter is not incremented so that the continuity counter of the redundant packet matches the continuity counter of the previously transmitted packet.

FIG. 6B provides an example of some of the information that is transmitted to the DHCT 16 to enable the DHCT 16 to parse out and route content to the proper destinations. As shown, the headers 618 of the MPEG application streams 614 include a Program Association Table (PAT) 610 and a Program Map Table (PMT) 612. The PAT 610 is carried in MPEG packets having a PID value of zero. The PAT 610 associates the MPEG programs transmitted from the headend 11 (FIG. 5) with their respective Program Map Table 612 using the PID value of the PMTs. For example, the PMT for program 1 has a PID value of 22.

A PMT 612 maps the elementary streams of a program to their respective PID streams, i.e., the stream of MPEG packets having a common PID value that carry the elementary stream. For example, for program 1 the video stream is carried in MPEG application packets having a PID value of 54, and the PID value for the audio stream is 48. The related content designated for the external device can have its own PID number (e.g., 49) that can be identified (and distinguished from audio content (PID 48) slated for the television set) as content slated for the external device for the particular program (e.g., program 1) using one or more bits in the header of the packet. In other embodiments, the content can be embedded in the video (or audio) stream (e.g., if in the video stream for program 1, using a PID value of 54).

### DHCT

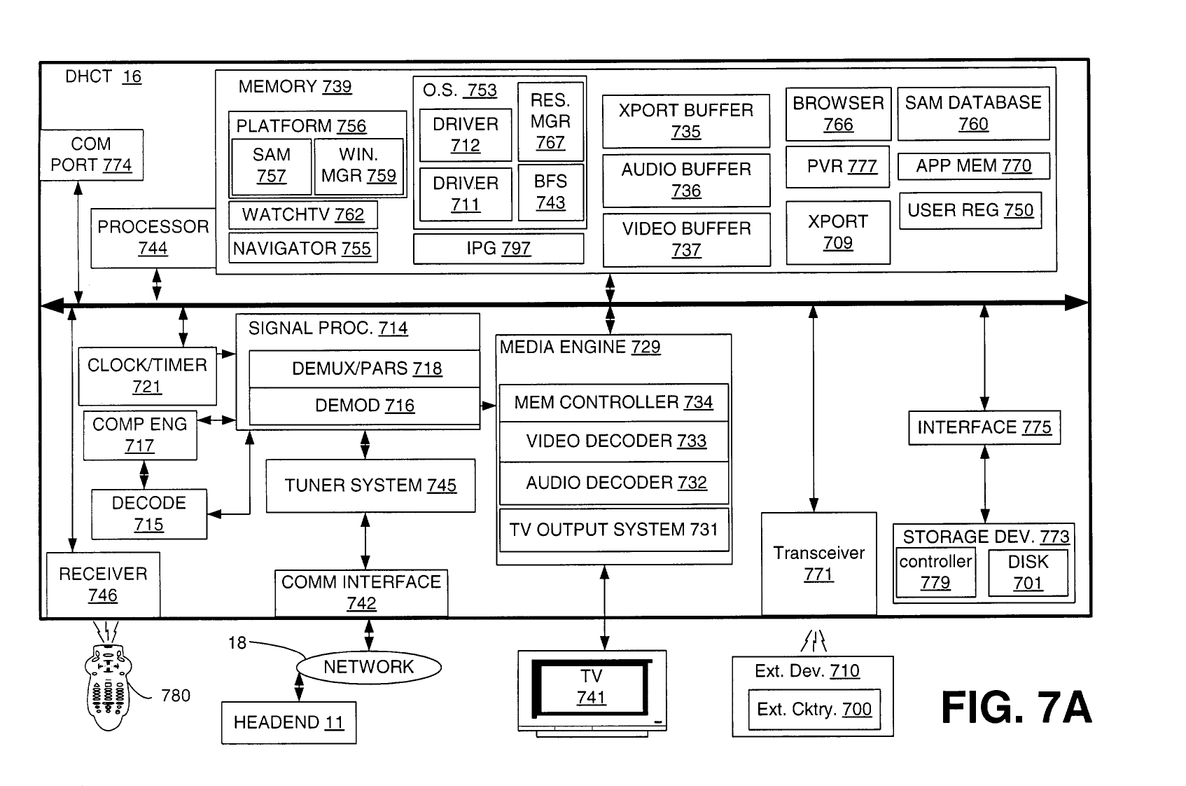

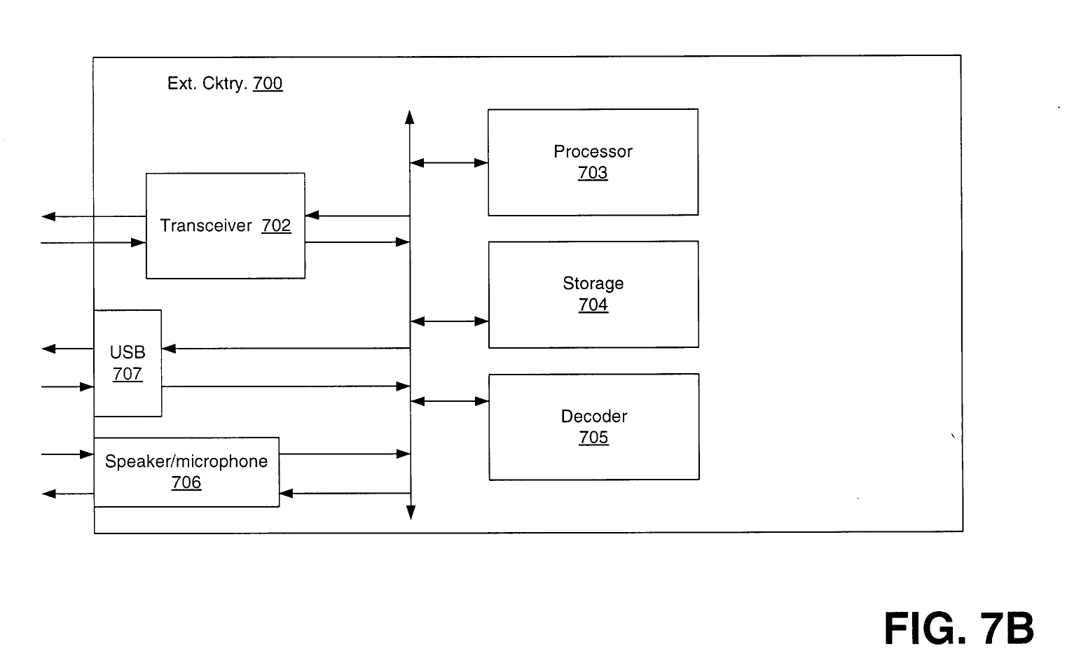

FIG. 7A is a block diagram illustration of an example DHCT 16 that is coupled to the headend 11, a television set 741, and an external device 710, in accordance with one embodiment of the invention. It will be understood that the DHCT 16 shown in FIG. 7A is merely illustrative and should not be construed as implying any limitations upon the scope of the preferred embodiments of the invention. For example, some of the functionality performed by applications executed in the DHCT 16 (such as the IPG application 797) may instead be performed completely or in part at the headend 11 and vice versa, or not at all in some embodiments. A DHCT 16 may be a stand-alone unit or integrated into another device such as, for a non-limiting example, a television set or a personal computer or other display devices or an audio device, among others. The DHCT 16 preferably includes a communications interface 742 for receiving signals (video, audio and/or other data) from the headend 11 through the network 18, and provides for reverse information to the headend 11 through the network 18.

The DHCT 16 preferably includes one or more processors, such as processor 744, which controls the functions of the DHCT 16 via a real-time, multi-threaded operating system 753 that enables task scheduling and switching capabilities. The DHCT 16 also includes a tuner system 745 comprising one or more tuners for tuning into a particular television channel or frequency to display content and for sending and receiving various types of content to and from the headend 1. The tuner system 745 can select from a plurality of transmission signals provided by the subscriber television system 10 (FIG. 1). The tuner system 745 enables the DHCT 16 to tune to downstream content transmissions, thereby allowing a user to receive digital and/or analog content delivered in the downstream transmission via the subscriber television system. The tuner system 745 includes, in one implementation, an out-of-band tuner for bi-directional QPSK (or QAM in some embodiments) communication and one or more QAM tuners (in band) for receiving television signals. Additionally, a receiver 746 receives externally generated information, such as user inputs or commands from an input device, such as a remote control device 780, or an external device 710. The DHCT 16 also includes a transceiver 771 that is driven by a transceiver driver 711 in the operating system 753 that preferably formats the signal to enable communication to (and from) an external device 710. The transceiver 771 can be configured as RF, IR, wired/Ethernet, wired/USB, and/or wired/coax, among others, and preferably includes one or more registers (not shown) that the transceiver driver 711 can read (i.e., via the processor 744) to determine performance characteristics of the external device 710 (as communicated by the external device 710). The transceiver 771 preferably includes a local cache (not shown) for temporarily storing related content to be downloaded to the external device 710. The related content loaded to the cache can come from a decoder buffer (not shown) resident in memory 739, or in memory local to the media engine 729, or preferably from the XPORT buffer 735 for implementations where the external device 710 includes decoding functionality. Memory 739 can be volatile memory and/or non-volatile memory. The XPORT buffer 735 is preferably used to buffer related content for subsequent delivery to the external device 710. In other embodiments, the DHCT 16 can communicate with the external device 710 using RF or IR transceivers coupled to one or more communication ports 774, where drivers associated with those ports can be used to drive the coupled transceiver.

The DHCT 16 includes a signal processing system 714, which comprises a demodulating system 716 and a transport demultiplexing and parsing system 718 (herein demux/parse system 718) to process broadcast content. One or more of the systems of the signal processing system 714 can be implemented with software, a combination of software and hardware, or preferably in hardware. The demodulating system 716 comprises functionality for RF signal demodulation, either an analog transmission signal or a digital transmission signal. For instance, the demodulating system 716 can demodulate a digital transmission signal in a carrier frequency that was modulated, for a non-limiting example, as a QAM-modulated signal.

When tuned to a carrier frequency corresponding to an analog TV signal transmission, the demux/parse system 718 is bypassed and the demodulated analog TV signal that is output by the demodulating system 716 is instead routed to an analog video decoder 715. The analog video decoder 715 converts the analog video signal (i.e., the video portion of a content instance that comprises a video portion and an audio portion) received at its input into a respective non-compressed digital representation comprising a sequence of digitized pictures and their respective digitized audio. Presented at the input to the analog video decoder 715 is an analog video signal such as NTSC video comprising of audio and video. The analog video decoder 715 outputs the corresponding sequence of digitized pictures and respective digitized audio. The analog video decoder 715 can also extract information outside the visible television picture field. For example, closed-captioning and time signals are preferably encoded during the vertical blanking interval (VBI). Synchronization is “built into” analog transmission. For example, the audio is in synchronization with the video primarily due to the fact that video and audio are transmitted at the same time. The DHCT 16 thus infers synchronization by the time base of the transmitted analog signal. In turn, the DHCT 16 can cause synchronization (or non-synchronization) with the presentation at the external device 710 using methods somewhat similar to those used for digital content, such as using synch packets as is described below. Further, information can be embedded in the horizontal blanking interval, such as duration-encoding the chroma burst. Thus, a digital stream carrying television information, including the related content that is to be downloaded to the external device 710, can be encoded in an analog broadcast, circumventing or supplementing the use of MPEG for transmission of content.

Note that a single DHCT 16 can support multiple incoming multimedia formats and convert all of these formats to a single format for delivery to the external device 710. For example, a DHCT 16 can receive multiple analog data formats (such as horizontal blanking interval, vertical blanking interval, and/or light-intensity modulation) and digital formats (such as an MPEG-2 data stream) and convert all of them to a single, well-understood format such as a data stream over infrared. Thus, the external device 710 can receive data streams initially sourced from a variety of data sources and data source formats. Additionally, future formats developed after the manufacture of a particular external device can be supported simply by downloading new software into the DHCT 16.

Digitized pictures and respective audio output by the analog video decoder 715 are presented at the input of a compression engine 717. Digitized pictures and respective audio output by the analog video decoder 715 can also be presented to an input of a media engine 729 via an interface (not shown) dedicated for non-compressed digitized analog video and audio, such as ITU-656 (International Telecommunications Union or ITU), for display on TV 741 or output to the external device 710, using memory 739 as an intermediary step to buffer the incoming content. The compression engine 717 is coupled to memory 739 and additionally to a local dedicated memory (not shown) that is preferably volatile memory (e.g., DRAM), for input and processing of the input digitized pictures and their respective digitized audio. Alternatively, the compression engine 717 can have its own integrated memory (not shown). The compression engine 717 processes the sequence of digitized pictures and digitized audio and converts them into a video compressed stream and an audio compressed stream, respectively. The compressed audio and video streams are produced in accordance with the syntax and semantics of a designated audio and video coding method, such as that specified by the MPEG-2 audio and MPEG-2 video ISO (International Organization for Standardization or ISO) standard, among others, so that they can be interpreted by a video decoder (or video decompression engine) 733 and/or an audio decoder (or audio decompression engine) 732 resident in the DHCT 16 (and/or decoded at an external device that includes decoding functionality, such as the external device 710) for decompression and reconstruction at a future time. Synchronization is native to analog signal transmission, as seen in analog broadcasts that are processed and sent via the TV output system 731 to the television 741 for display of the video and audio in addition to presenting text for the hearing impaired. Related content designated for delivery to the external device 710 can be buffered in the XPORT buffer 735 and then downloaded to a local cache of the transceiver 771 for subsequent delivery that occurs in synchronization with the signals decoded and presented to the television set 741 (e.g., instead of routing the audio to the television set 741, the audio is routed to the external device 710, in some implementations).

The compression engine 717 multiplexes the audio and video compressed streams into a transport stream, such as an MPEG-2 transport stream, for output. Furthermore, the compression engine 717 can compress audio and video corresponding to more than one content instance in parallel (e.g., from two tuned analog TV signals when the DHCT 16 possesses multiple tuners) and to multiplex the respective audio and video compressed streams into a single transport stream. For example, in one embodiment, related content that is designated for download to the external device 710 can be delivered at one frequency at the time the content slated for the television 741 is delivered from the headend 11 at another frequency.

The output of compressed streams and/or transport streams produced by the compression engine 717 is input to the signal processing system 714. Parsing capabilities within the demux/parse system 718 of the signal processing system 714 allow for interpretation of sequence and picture headers, for instance, annotating their locations within their respective compressed stream for future retrieval from a storage device 773 and/or for acquiring routing instructions for particular buffer destinations in memory 739, as described below. A compressed analog content instance (e.g., TV program episode or show) corresponding to a tuned analog transmission channel can be output as a transport stream by the signal processing system 714 and presented as input for storage in the storage device 773 via the interface 775. The packetized compressed streams can also be output by the signal processing system 714, buffered in video, audio, and/or XPORT buffers 735-737, and presented as input to the media engine 729 for decompression by video decompression engine 733 and audio decompression engine 732 and then output for display on the TV 741. In some implementations, the content designated for the external device 710 can be buffered in the XPORT buffer 735 and processed and routed using the transceiver driver 711 to the local cache for the transceiver 771, and then transmitted to the external device 710, thus bypassing the DHCT decoding functionality due to decoding functionality resident in the external device 710.

The demux/parse system 718 can include MPEG-2 transport demultiplexing. When tuned to carrier frequencies carrying a digital transmission signal, the demux/parse system 718 enables the separation of packets of data, corresponding to the compressed streams of information belonging to the desired content instances, for further processing. Concurrently, the demux/parse system 718 precludes packets in the multiplexed transport stream that are irrelevant or not desired, such as packets of data corresponding to compressed streams of content instances of other content signal sources (e.g., other TV display channels), from further processing.

The parsing capabilities of the demux/parse system 718 includes reading and interpreting the received transport stream without disturbing its content, such as to interpret sequence and picture headers, for instance, to annotate their locations and corresponding time offset within their respective compressed stream for future retrieval from the storage device 773 and/or for downloading to the external device 710 at defined times before, during, and/or after the presentation of the content instance on the television set 741. Thus, the components of the signal processing system 714 are capable of QAM demodulation, forward error correction, and demultiplexing of MPEG-2 transport streams, and parsing of elementary streams and packetized elementary streams. A compressed content instance corresponding to a tuned carrier frequency carrying a digital transmission signal can be output as a transport stream by the signal processing system 714 and presented as input for storage in the storage device 773 via the interface 775 as will be described below. The packetized compressed streams can be also output by the signal processing system 714, buffered to the video, audio, and/or XPORT buffers 735-737, and presented as input to the media engine 729 for decompression by the video decompression engine 733 and the audio decompression engine 732 (or bypassing the decoding functionality and processed for transport to the transceiver 771 for transmission to the external device 710).

One having ordinary skill in the art will appreciate that the signal processing system 714 will preferably include other components not shown, including local memory, decryptors, samplers, digitizers (e.g., analog-to-digital converters), and multiplexers. Further, other embodiments will be understood, by those having ordinary skill in the art, to be within the scope of the preferred embodiments of the present invention, including analog signals (e.g., NTSC) that bypass one or more elements of the signal processing system 714 and are forwarded directly to the output system 731 (or transceiver 771).

The media engine 729 includes the digital video decoder 733, digital audio decoder 732, memory controller 734, and TV output system 731. In some embodiments, the media engine 729 can include other digital signal processing components (not shown) as would be understood by those having ordinary skill in the art. For a non-limiting example, the demux/parse system 718 is in communication with the tuner system 745 and the processor 744 to effect reception of digital compressed video streams, digital compressed audio streams, and/or data streams corresponding to one or more content instances to be separated from other content instances and/or streams transported in the tuned transmission channel and to be stored in buffers 735, 736, and/or 737 in memory 739 assigned to receive packets of one or more content instances.

In one implementation, compressed video and audio streams received through an in-band tuner or read from the local storage device 773 are deposited continuously into the audio, video, and/or XPORT buffers (736, 737, and 735, respectively) of memory 739. Thereafter, one or more video decoders 733 in the media engine 729 decompress compressed MPEG-2 Main Profile/Main Level video streams read from one or more of buffers 735 and 737. Each picture decompressed by the video decoder 733 is written to a picture buffer (not shown) in memory 739 or local memory (not shown) dedicated to the media engine 729, where the reconstructed pictures are retained prior to presenting to the output system 731.

Additionally, one or more audio decoders 732 in the DHCT 16 can decode the compressed digital audio streams associated with the compressed digital audio or read as an audio object from the local storage device 773 in a similar fashion, allocating respective buffers as necessary.

In embodiments wherein an external device, such as the external device 710, includes decoding functionality, the video, audio, and/or other data comprising the content in the XPORT buffer 735 can bypass the decoding functionality of the media engine 729. For example, a signal from the external device 710 to the transceiver 771 (or to the communication port 774 when a physical connection is made) will cause the processor 744 (in cooperation with the operating system 753) to alert the responsible device driver (e.g., the transceiver driver 711), which will read one or more transceiver registers (not shown) to determine the characteristics of the signaling external device 710. For example, determinations as to when an external device includes decoding functionality can be made based on the received information (i.e., received from the external device 710) that is loaded into the transceiver registers. The registers can include a device identification that the transceiver driver 711 or operating system 753 can use to determine the characteristics from an internal look up table (not shown), or one or more flag bits received into the registers are recognized by the transceiver driver 711 as indicative of decoding functionality or not. In IR transceiver embodiments, a code registry (not shown) can be maintained and used by the operating system 753 or a device driver to look up the meaning of certain prefix, suffix, and/or alternate codes sent from the external device 710. These codes can be indicative, for example, of certain performance parameters of the external device 710, such as whether decoding functionality exists or not.

Note that other embodiments for acknowledging the external device 710 and/or determining performance parameters of the external device 710 are within the scope of the preferred embodiments of the invention. As one example, the user may provide input (via a menu or configuration screen, not shown) to the DHCT 16 alerting the DHCT 16 to the presence of an external device. From there, a graphics user interface (GUI) can be displayed on the television set 741 that guides a user through one or more screens or menus that enable the user, via the remote control device 780, to identify the performance characteristics of the external device, using pre-configured categories and/or enabling user entry through alphanumeric input. Such an embodiment enables the DHCT 16 to coordinate the delivery of related content using one-way communication (e.g., using a transmitter in lieu of, or in addition to, using a transceiver 771). As another example, the external device 710 can alert the DHCT 16 of its presence, which prompts an external device icon (not shown) on the television display. The user can select the icon, and will similarly be presented with a preconfigured list (or otherwise) enabling the performance characteristics to be ascertained by the DHCT 16 through user input using the remote control device 780.

The media engine 729 processes signals for output via the TV output system 731 to a television set 741 or other display device and for output to an external device lacking decoding functionality. The TV output system 731 preferably comprises an RF Channel 3 and 4 output to drive an analog TV set or display or other device such as a VCR, as well as an output video port to drive a display, monitor or TV set that receives an analog TV signal at its input. Additionally, it should be understood that the TV set or display may be connected to the DHCT 16 via a video port such as Composite Video, S-Video, or Component Video, among others. The TV output system 731 can also comprise Digital Component Video or an IEEE-1394 interface to drive a TV set or display that receives non-compressed digital TV signals at its input. The TV output system 731 also includes a Digital Video Encoder (DENC) (not shown) that converts reconstructed video data received at its input to an analog video signal that drives a connected TV display. Data is fed to the DENC from media engine memory (not shown) or memory 739 in a manner to produce a raster scan of displayed pixels consistent with the display type connected to the DHCT 16.

A memory controller 734 in the DHCT 16 grants access to transfer data from system memory 739 to the display buffer (not shown) in the media engine memory in a timely way that safeguards from the generation of tear artifacts on the TV display. Data transfer is granted to locations in the display buffer corresponding to locations already passed by the raster-scan ordered data fed from display buffer into the DENC. Thus, data written to the display buffer is always behind (in raster-scan order) the display buffer locations read and fed into the DENC. Alternatively, data can be written to a secondary display buffer (not shown), also called an off-screen or composition buffer. The off-screen buffer, or parts thereof, are then transferred to the display buffer by effecting a media memory-to-media memory data transfer during suitable times (e.g., during the vertical blanking video interval). The off-screen buffer and display buffer can be alternated in meaning under program control upon completion of writing all objects into the off-screen buffer. The memory controller 734 uses a pointer that points to the beginning of the display buffer and another pointer that points to the beginning of the off-screen buffer. Both pointers are stored in either memory 739 or special registers internal to the memory controller 734. Therefore, to effectuate alternating the meaning of the display buffer and the off-screen buffer, the content of the two pointer repositories are swapped.

The DHCT 16 includes at least one internal clock and timer 721. Transmission of data packets containing a time specification from the headend 11 enables the DHCT 16 to synchronize its clock and keep track of time and intervals of time, as described in the headend description associated with FIG. 5. For example, in implementations where content is to be presented at the external device 710 to provide synchronized audio with the related content presented on the television set 741, time stamps 611 (FIG. 6A) in the data stream sent from the headend 11 can be used by the processor 744 (and/or processor of the external device 710) to enable synchronization between the presented TV show and the audio from the external device 710. This can be done using a just in time approach, wherein the PCR/SCR feature that MPEG natively supports is sent contemporaneously with the stream slated for the television set 741. Another implementation can include sending the related content ahead of time for storage in the storage device 773, in memory 739, or in the XPORT buffer 735. A trigger can be sent from the headend 11 that causes an XPORT application 709 (described below) to awaken and cause the related content to be downloaded and subsequently presented in synch with the corresponding video presented on the television 741.

The DHCT 16 can include one or more storage devices, such as storage device 773, preferably integrated into the DHCT 16 through an IDE or SCSI interface 775, or externally coupled to the DHCT 16 via a communication port 774. The storage device 773 can be optical (e.g. read/write compact disc), but is preferably a hard disk drive. The storage device 773 includes one or more media, such as hard disk 701. A storage device controller 779 in the storage device 773 of DHCT 16, in cooperation with a device driver 712 and the operating system 753 (to be described below), grants access to write data to or read data from the local storage device 773. The processor 744 can transfer content from memory 739 to the local storage device 773 or from the local storage device 773 to the memory 739 by communication and acknowledgement with the storage device controller 779.

In one implementation, the DHCT 16 includes memory 739, which includes volatile and/or non-volatile memory, for storing various applications, modules and data for execution and use by the processor 744. Basic functionality of the DHCT 16 is provided by an operating system 753. Among other things, the operating system 753 includes at least one resource manager 767 that provides an interface to resources of the DHCT 16 such as, for example, computing resources, and a broadcast file system (BFS) client 743 that cooperates with a BFS server (not shown) to receive data and/or applications that are delivered from the BFS server in a carousel fashion. The operating system 753 further includes device drivers, such as device driver 711 and 712 that works in cooperation with the operating system 753 to provide operating instructions for communicating with external devices, such as external device 710 and/or the storage device 773.

Memory 739 also includes the XPORT application 709, which is used to enable the multimedia system functionality of the DHCT 16, in accordance with one embodiment of the invention. In other embodiments, the functionality of the XPORT application 709 can be embodied as a module in various software applications, such as a module in the WatchTV application 762 (an application that provides for broadcast television services), the operating system 753, or other layers or levels of software and/or hardware control. The XPORT application 709 includes functionality for effecting the retrieval of related content from a data stream, routing related content to an appropriate buffer or buffers, and interpreting time stamps for the related content designated for transmittal and/or download to the external device 710 in association with the presentation of a content instance on the television set 741. The XPORT application 709 provides this functionality in cooperation with other components of the DHCT 16, the headend 11, and the external device 710.

For example, detection of the external device 710 may be performed by polling mechanisms or interrupt mechanisms associated with the processor 744, which the XPORT application 709, as an application that has registered to receive and/or transmit information from a receiving port, uses to prepare for receiving content from a data stream. The characteristics of the external device 710 (e.g., decoding functionality, etc.) may be acquired by the transceiver driver 711, which the XPORT application 709 cooperates with to decide whether to route the content from the XPORT buffer 735 to decoding functionality in the DHCT 16 and/or to process (in cooperation with the transceiver driver 711) for transmittal to the external device 710. In an alternate embodiment, the DHCT 16 is notified of the external device 710 via a user interface displayed on the television 741, and by the user entering information via his or her remote control device 780, as described previously. In other embodiments, the XPORT application 709, upon receiving certain triggers in the data stream (e.g., indicating associated data streams carrying related content available for downloading to the external device 710), can cause the polling mechanisms and information acquiring mechanisms to be activated as opposed to taking a more passive role in the process.

As one example implementation, upon receiving an indication that the external device 710 is within range to receive program related content, the XPORT application 709 can start looking for PIDs having associated elementary streams of the current programming in conjunction with the PID parsing occurring under the direction of the WatchTV application 762. The XPORT application 709 “knows” which PIDs to look for according to several mechanisms. For example, the XPORT application 709 can query the WatchTV application 762 as to what service (e.g., frequency for analog transmission or frequency and program number for digital transmission) the WatchTV application 762 is currently tuned into, and then the XPORT application 709 can effect tuning to the associated data stream (carrying the related content). In other embodiments, the headend 11 can download a lookup table (or directory) of supported clients and “services” via the BFS server-client process described previously. The XPORT application 709, alone or in cooperation with the BFS client 743, can scan the lookup table for a list of static files to download to the external device 710 from the BFS server as well as a list of frequencies and PIDs. Still in other embodiments, the activation of the XPORT application 709 can result in a selection guide being presented on the television set display, enabling a user to select a channel on which the content for the external device 710 is to be extracted from, which may be carried in the same or different data stream as the content designated for the television. For example, the content designated for the television set 741 can be sent in an in-band signal path under one frequency, and the related content (or unrelated content) can be retrieved from a second frequency in the in-band signal path using a second tuner. Or in other embodiments, the content designated for the television set 741 can be in an in band signal path and the related content (or unrelated content) can be sent out-of-band.

Received content that is to be transferred to the external device 710 is preferably buffered in the XPORT buffer 735. Times of release (or withdrawal) of the content from the XPORT buffer 735 (and the audio and video buffers 736, 737) are, in one embodiment, dictated by the time stamps 611 (FIG. 6A) associated with and stored in the XPORT buffer 735, as determined through the timing/clock/counter mechanisms of the DHCT 16 in cooperation with the timing mechanisms native to MPEG transport and/or higher-layer extensions to the standard. For synchronization of video and audio for a particular content instance with the synchronization of audio in the external device 710, the time stamp values are generally mirrored in each buffer. For content that is to be presented in the external device 710 in a non-synchronous (or partial synchronous) manner, the time stamps 611 downloaded to the XPORT buffer 735 may have time values that are within a window of times corresponding to the duration of the particular content instance that the content is associated with. Further, the decision as to whether to present to the external device 710 in synchronization with the television set content or to have deferred presentation content can be based on instructions in the received data stream that indicate the content is for deferred presentation, or the decision can be made by the user interfacing with a GUI (especially in the case where both types of content for these types of presentations are available), or the absence of elements used to generate the time stamps (e.g., the absence of a PCR) can be used as a “flag” that synchronization is not available or intended.

In one embodiment, the local clock (not shown) in the external device 710 is synchronized with the clock/timer 721 of the DHCT 16. The PCR code in the PID destined for the external device 710 can specify the exact time at which the transceiver 771 is to begin transmitting a “synch packet”. After receiving a few of these “synch packets” and measuring their inter-arrival times, the local clock of the external device 710 should be well-synchronized to the clock/timer 721. Events are preferably synchronized via timestamps against the synchronized local clock of the external device 710. That is, the events represent time stamps using the local clock of the external device 710. Further, a protocol table can be sent from the DHCT 16 to the external device 710. The protocol table can be created in several ways. In one embodiment, the protocol table can be downloaded to the DHCT 16 by the headend 11, and from the DHCT 16 to the external device 710 when the external device 710 establishes communication with the DHCT 16. The semantics of the protocol table can be enforced by downloading a program that understands the protocol table format or by expressing the behavior of the protocol table using a well-understood format that expresses behavior, such as XML, among others. In another embodiment, the protocol table can represent an agreed-upon standard used by both DHCT manufacturers and external device manufacturers and therefore not require downloading. The protocol table can be of the following example format:

[Event type] [Time] [Action]

where “event type” is 1=At a certain time, 2=immediate, 3=in response to user input. As one example,

[1][10:06:23.74][Play audio clip that says “Get in shape!”]

[2][ - - - ] [Move arms up and down]

[3] [When red button is pressed][Make a BANG sound].

Note that other mechanisms can be employed to coordinate or execute the presentation time of the related content, in accordance with the preferred embodiments of the invention.

One or more programmed software applications, herein referred to as applications, are executed by utilizing the computing resources in the DHCT 16. Note that an application typically includes a client part and a server counterpart that cooperate to provide the complete functionality of the application. The application clients may be resident in memory 739 or the storage device 773, or stored in a combination of one or more of the memory 739 and storage device 773. Applications stored in memory 739 (or storage device 773) are executed by the processor 744 (e.g., a central processing unit or digital signal processor) under the auspices of the operating system 753. Data required as input by an application is stored in memory 739 or storage device 773 (or a combination) and read by the processor 744 as need be during the course of the application's execution.

Input data may be stored in memory 739 by a secondary application or other source, either internal or external to the DHCT 16, or possibly anticipated by the application and thus created with the application at the time it was generated as a software application. Data generated by an application is stored in memory 739 by the processor 744 during the course of the application's execution, or if required, transferred to the storage device 773 from memory 739 by the processor 744 during the course of the application's execution. The availability of data, location of data, whether in memory 739 or in the local storage device 773, and the amount of data generated by a first application for consumption by a secondary application is communicated by messages. Messages are communicated through the services of the operating system 753, such as interrupt or polling mechanisms or data sharing mechanisms such as semaphores.

An application referred to as a navigator 755 is resident in memory 739. The navigator 755 provides a navigation framework for services provided by the DHCT 16. For instance, the navigator 755 includes core functionality such as volume and configuration settings. The navigator 755 preferably handles channel navigation keys on the remote control device 780. It also preferably displays a channel banner with information about the selected channel. The navigator 755 registers for and in some cases reserves certain user inputs related to navigational keys such as channel increment/decrement, last channel, favorite channel, etc. Thus, the navigator 755 associates the XPORT application 709 with the transceiver 771, as one example. The navigator 755 also provides users with television related menu options that correspond to DHCT functions such as, for example, blocking a channel or a group of channels from being displayed in a channel menu.

The memory 739 also contains a platform library 756. The platform library 756 is a collection of utilities useful to applications, such as a timer manager, a compression manager, a configuration manager, an HTML parser, a database manager, a widget toolkit, a string manager, and other utilities (not shown). These utilities are accessed by applications via application programming interfaces (APIs) as necessary so that each application does not have to contain these utilities. Two components of the platform library 756 that are shown in FIG. 7A are a window manager 759 and a service application manager (SAM) client 757. Note that in other embodiments, one or more of the platform library components may be resident in the operating system 753. The window manager 759 provides a mechanism for implementing the sharing of the display device screen regions and user input. The window manager 759 on the DHCT 16 is responsible for, as directed by one or more applications, implementing the creation, display, and de-allocation of the limited DHCT 16 screen resources. It allows multiple applications to share the screen by assigning ownership of screen regions, or windows.

The window manager 759 also maintains, among other things, a user input registry 750 in memory 739 so that when a user enters a key or a command via the remote control device 780 or another input device such as a keyboard or mouse, the user input registry 750 is accessed to determine which of various applications running on the DHCT 16 should receive data corresponding to the input key and in which order. The XPORT application 709 maps gracefully into this environment. For example, pressing a button on a doll (not shown), for example, can be converted by the XPORT application 709 into a channel-up event that is recognized by the WatchTV application 762.

The SAM client 757 is a client component of a client-server pair of components, with the server component being located on the headend 11, typically in the control system 532 (FIG. 5). A SAM database 760 (i.e. structured data such as a database or data structure) in memory 739 includes a data structure of services and a data structure of channels that are created and updated by the headend 11. Herein, database will refer to a database, structured data or other data structures as is well known to those of ordinary skill in the art. Many services can be defined using the same application component with different parameters. Examples of services include, without limitation and in accordance with one implementation, presenting television programs (available through a WatchTV application 762), presenting related content to external devices (available through the XPORT application 709), pay-per-view events (available through a PPV application (not shown)), digital music (not shown), media-on-demand (available through an MOD application (not shown)), and an interactive program guide (IPG) (available through an IPG application 797).

In general, the identification of a service includes the identification of an executable application that provides the service along with a set of application-dependent parameters that indicate to the application the service to be provided. For example, a service of presenting a television program could be executed by the WatchTV application 762 with a set of parameters to view HBO or with a separate set of parameters to view CNN. Each association of the application component (tune video) and one parameter component (HBO or CNN) represents a particular service that has a unique service I.D. The SAM 757 also provisions for invoking a second application in response to a first application request to launch the second application, such as the WatchTV application 762 invoking the XPORT application 709. Hence, it is possible through an Application Programming Interface (API) for any application in the DHCT 16, including the navigator 755, to request an application stored in the storage device 773 or elsewhere to launch by first transferring the application's executable program to memory 739 and allocating memory 739 and/or storage capacity for data input and output. Thus the XPORT application 709 could potentially have full control of the DHCT 16, including tuning it and even turning it off. The SAM client 757 also interfaces with the resource manager 767, as discussed below, to control resources of the DHCT 16.

In the example DHCT 16 depicted in FIG. 7A, memory 739 also includes a web browser application 766, a personal video recording (PVR) application 777, and the XPORT application 709 (in addition to those mentioned above), as well as other components including application memory 770, which various applications may use for storing and/or retrieving data. It should be clear to one with ordinary skill in the art that these applications are not limiting and merely serve as examples for this present embodiment of the invention. These applications, and others provided by the cable system operator, are top level software entities on the network for providing services to the user.

An executable program or algorithm corresponding to an operating system (OS) component, or to a client platform component, or to an application, or to respective parts thereof, can reside in and execute out of memory 739 and/or the storage device 773. Likewise, data input into or output from any executable program can reside in memory 739 and/or the storage device 773.

### External Device Circuitry

FIG. 7B is an example of external device circuitry 700 for the external device 710 depicted in FIG. 7A, in accordance with one embodiment of the invention. The external device circuitry 700 preferably includes a transceiver 702 (IR or RF, among others) that is compatible with the external communication circuitry of the DHCT 16. In an alternate embodiment, the external device 710 can be equipped with a receiver instead of a transceiver 702, wherein all communications is unidirectional from the DHCT 16 to the external device 710. The external device circuitry 700 also includes a processor 703 (e.g., a microprocessor with clock and/or timing mechanisms (not shown)), storage 704 for the downloaded content and executable instructions, a speaker and/or microphone 706, and a decoder 705 (audio and/or video decoder). Other components can be included (and/or one or more of the aforementioned components omitted), depending on the nature of the external device in which the external device circuitry 700 is embedded within. For example, additional components can include lights, graphical outputs, actuators for arms and/or legs, communications and/or processing support for a printer, or other peripheral support. The external device circuitry 700 may also include communication ports, such as universal serial bus (USB) 707, among others. The processor 703 may be enabled or “awakened” by the emitted digital and/or analog stream from the DHCT 16, such as before, during, and/or after the presentation of a particular show, which causes the processor 703 to cause a reply back to the DHCT 16 via the transceiver 702, acknowledging that it is within receiving range and ready for transmitted content. In other embodiments, the external device circuitry 700 can send out a registration signal to the DHCT 16 when the external device 710 is switched on, or responsive to other stimuli, such as the detection of a light intensity modulated signal emitted from the television set 741 (FIG. 7A), to alert the DHCT 16 that it is nearby and ready to receive content. Alternatively, the user may notify the DHCT 16 via a GUI displayed on a television 741 using the remote control device 780 (FIG. 7A) in cooperation with the DHCT 16. One skilled in the art would understand that the external device circuitry 700 can be implemented using software and/or hardware, and can be equipped with other components such as switches, sensors, actuators, demodulators, graphical displays, conditional access components, analog to digital (A/D) and digital to analog (D/A) components, among other components.

### Example Implementation for Transmitting Related Content

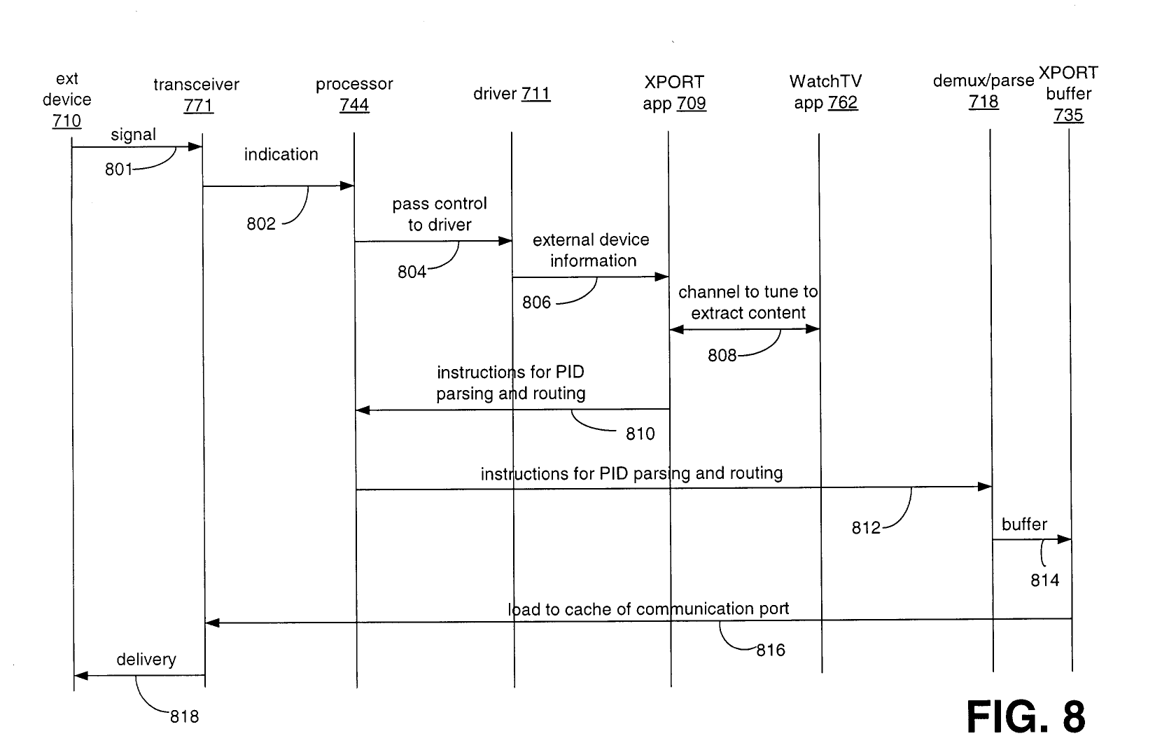

With continued reference to FIGS. 7A-7B, FIG. 8 is a timing diagram showing one example implementation for detecting the external device 710 (having decoding functionality) and sending it related content, in accordance with one embodiment of the invention. Step 801 includes receiving a signal from the external device 710 to the transceiver 771. This communication between the DHCT 16 and the external device 710 can be implemented in several ways. For example, the external device 710 can be physically connected to the DHCT 16, or the external device 710 can broadcast a signal continuously while activated (e.g., switched on) or broadcast at defined intervals. Further, the user can make the DHCT 16 aware of the presence of the external device 710 (e.g., via a remote control device with or without the aid of a GUI presented on the television display). Another example includes the external device 710 automatically responding to a signal emitted from the DHCT 16 and/or from the television display. The signal emitted from the DHCT 16 can be broadcast continuously while the DHCT is powered on, or at defined intervals, for example, when a content instance associated with the related content to be sent to the external device 710 is being presented (or is about to be presented, or has been presented).

In an alternate embodiment, the external device 710 may be connected to the DHCT through a local-area network. Well known networks such as Ethernet, Home Phoneline Networking Alliance 2.0 (HPNA 2.0), HomePlug Alliance (HomePlug), and Wireless Ethernet (IEEE Standard 802.11b) provide for two-way communication among devices, and such networks can provide the mechanisms by which a DHCT 16 and external device 710 may communicate. In one embodiment, an attached external device 710 can broadcast its existence to the network and the DHCT 16 responds. This can be accomplished, for example, by having the external device 710 use the well-known DHCP protocol to request an IP (network) address from the DHCT 16. In another embodiment, the DHCT 16 and the external device 710 use a resource-discovery protocol to discover one another and their respective capabilities. Non-limiting examples of such protocols include Jini, UPnP, Salutation, and HAVi, among others.

Step 802 includes receiving an indication from the transceiver 771 of the DHCT 16 via a polling mechanism or interrupt. Note that the indication can include information such as the address of an application that has registered for an event occurring at the particular communication port (e.g., the XPORT application 709), the address of the associated driver code, and/or information that can be conveyed in the signal and downloaded to a register of the transceiver 771. Step 804 includes passing control to the transceiver driver 711 to acquire information and service the interrupt. The acquired information is passed to the XPORT application 709 (step 806). For example, the XPORT application 709, upon being alerted to the presence of the external device 710, awaits information from the transceiver driver 711 such as the identity of the external device 710 and corresponding performance characteristics, such as the fact that the external device 710 has decoding functionality for audio (e.g., as determined by flag bit or bits, unique code, etc.). In other embodiments, the XPORT application 709 could operate in a 1-way mode (e.g., submissive mode), in which the WatchTV application 762 activates the XPORT application 709 and uses it to broadcast data to the external device 710 when the WatchTV application 762 discovers a data PID in the current program associated with related content.

Upon receiving the information from the transceiver driver 711, the XPORT application 709 can query the WatchTV application 762 as to what channel the WatchTV application 762 is currently tuned to (step 808), and then use that information (along with information about the external device characteristics) to instruct the processor 744 to extract PIDs at the channel that the WatchTV application 762 is extracting PIDs (step 810). Further, the XPORT application 709 can request that certain PID values (for related content) be extracted from that channel and routed to the XPORT buffer 735 under a table corresponding to operations that involve subsequent non-DHCT decoding, as one example. Responsive to these instructions, the processor 744 directs the demux/parse system 718 to parse out the content slated for the external device 710, and route to the XPORT buffer 735 (step 812).

The demux/parse system 718, according to mechanisms described above, demultiplexes the requested PIDs, and parses out the headers and payloads from the delivered transport (and/or program) streams to determine, in cooperation with the clock/timer 721, the processor 744, and the operating system 753, what time stamps to associate to the elementary streams stored in the XPORT buffer 735 (and the other buffers) to enable proper timing of the download to the external device 710 (and presentation on the television set 741) (step 814). The demux/parse system 718 extracts the PCRs from the packets in which they were inserted. In a program stream, the count is placed in a packet header as an SCR, which the processor 744 can identify. In one implementation, the PCR/SCR codes are preferably used to control a numerically locked loop (not shown) integrated with the clock/timer 721 in the DHCT 16, which includes a variable frequency oscillator (not shown) based on a crystal which has a relatively small frequency range. The oscillator drives a similar sized counter (similar in size to that used in the headend 11). The state of the DHCT counter (in memory 739, not shown) is compared with the contents of the PCR/SCR and the difference is used to modify the oscillator frequency. When the loop reaches lock, the counter arrives at the same value as is contained in the PCR/SCR and no change in the oscillator occurs. Loop filters (not shown) are preferably used to reduce phase noise due to jitter. Once a synchronous clock, for example a 27 MHz clock, is available at the processor 744 of the DHCT 16, this can be divided down to provide a clock rate which drives time stamps 611 (FIG. 6) used to synchronize content presented on a television set with content downloaded to an external device, as described below.

In an alternate embodiment, if the data stream is sent using analog transport (such as vertical blanking interval, chroma burst length modulation, or light-intensity modulation) the vertical blanking interval itself can be used to establish a time base. The “synch packet” mechanism described above can be used to synchronize the external device 710 to the DHCT vertical synch time base.

In one implementation, the absence of the synchronization bit or byte (PCR/SCR codes) could be one indication to the XPORT application 709 that synchronization between the content presented to both devices (i.e., the DHCT 16 and the external device 710) is not to be implemented. In other embodiments, commands (e.g., the playback time) can be embedded in the data stream sent from the headend 11 (FIG. 5), which are parsed out and used by the XPORT application 709 in cooperation with the processor 744 and the timing/clock functionality of the DHCT 16 to present the content either in synchronization between the two devices or to just download the related content without synchronization (e.g., immediately). One example mechanism for coordinating the presentation at the external device described previously is the protocol table and the use of “synch packets”.

As the content is loaded to the buffers, the processor 744, under the direction of the XPORT application 709, concurrently retrieves the previously loaded content at the time stamp intervals and routes to the cache of the transceiver 771 (or communication port 774) (step 816). In this example implementation, the content is to be loaded to the transceiver buffer for non-synchronous delivery to the external device 710 (step 818) when the time stamp read from the non-decode section of the table in the XPORT buffer 735 indicates one time stamp value for all elementary stream entries. In such an implementation, control is passed to the transceiver driver 711, where the content is conditioned for delivery to the external device 710. In some embodiments, the signal may be conditioned, for example serialized and processed to prepare the signal for transmission according to an appropriate protocol (e.g., an IR data format or other protocols). Additional components can be included for processing the signal slated for the external device 710, such as digital to analog (D/A) conversion (or analog to digital (A/D) for analog input transmission signals that have not been digitized), among other elements as would be understood by one having ordinary skill in the art. Note further that in at least some of the memory transfers for some embodiments, direct memory access can be employed as would be understood by one having ordinary skill in the art.

If the content is to be delivered in synchronization with the content presented on the television 741, the content demuxed and parsed at the demux/parse system 718 would have been routed to a decode section in the XPORT buffer 735 indexed according to time stamps for decoding, in addition to time stamps for presentation. As content is buffered, the processor 744, under the direction of the XPORT application 709, causes the content to be retrieved from the buffers 735-737 at the decoding time stamp intervals, wherein the decoded content along with the presentation time stamps are then retained in decoded content buffers (not shown) associated with the media engine 729. Then, the processor 744 causes the content that is stored in the decoded content buffers (and the XPORT buffer 735) to be retrieved in synchronization based on the presentation stamps.

The XPORT application 709 can be implemented in hardware, software, firmware, or a combination thereof. In the preferred embodiment(s), the XPORT application 709 is implemented in software or firmware that is stored in a memory and that is executed by a suitable instruction execution system. If implemented in hardware, as in an alternative embodiment, the XPORT application 709 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The XPORT application 709, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention, particularly, any “preferred embodiments” are merely possible examples of implementations, merely setting forth a clear understanding of the principles of the inventions. Many variations and modifications may be made to the above-described embodiments of the invention without departing substantially from the spirit of the principles of the invention. All such modifications and variations are intended to be included herein within the scope of the disclosure and present invention and protected by the following claims.

Therefore, having thus described the invention, at least the following is claimed:

1. A method for providing multimedia content from an external device, the method comprising the steps of:
receiving first content from a client device, the first content encoded in a digital stream;
decoding the digital stream to produce decoded first content; and
presenting the decoded first content in synchronization with the presentation of second content presented at a display device.

2. The method of claim 1, further including the steps of receiving a first signal from the client device and, responsively, sending a response signal indicating a readiness to receive the first content.

3. The method of claim 1, further including the step of, responsive to being activated, sending a signal to the client device, the signal indicating a readiness to receive the first content.

4. The method of claim 1, further including the step of sending a signal to the client device, the signal including performance characteristics of the external device.

5. The method of claim 1, wherein the step of receiving first content from a client device includes the step of receiving synchronization information from the client device, wherein the synchronization information includes at least one of presentation time stamps, decoding time stamps, and embedded synchronization instructions that are used to synchronize the presentation of the decoded first content at the external device with the presentation of the second content at the display device.

6. The method of claim 1, wherein the first content and the decoded first content includes at least one of audio samples, video samples, and text.

7. The method of claim 1, wherein the first content and the decoded first content includes at least one of audio samples that are the verbatim audio spoken by a character on a television show presented at the display device, the verbatim audio corresponding to the second content, educational material related to a television education show corresponding to the second content presented at the display device, game content for a game with corresponding characters presented in a television show presented at the display-device, the game content including enhanced features for the game, merchandising offers, advertisements, calendars, schedules, dates, descriptive audio that enhances the viewing experience for a physically disabled person, closed captioning that enhances the viewing experience for a physically disabled person, and other information that enhances the viewing experience for a physically disabled person.

8. The method of claim 1, wherein the first content and the decoded first content are related to the second content by theme.

9. The method of claim 1, wherein the step of receiving the first content includes the step of receiving the first content using at least one of a two-way radio frequency communication, one-way radio frequency communication, two-way infrared communication, one-way infrared communication, and wired communication.

10. The method of claim 1, further including the step of sending feedback information to the client device to be communicated to a program provider, wherein the feedback information includes at least one of user information, tests to be evaluated, contest registrations, and purchase orders.

11. The method of claim 1, wherein the step of synchronizing includes the steps of receiving synch packets from the client device, the synch packets including presentation time stamps, measuring the inter-arrival times of the synch packets, and using the measurement to match a clock rate of the client device to an internal clock rate of the external device.

12. The method of claim 1, wherein the digital stream is a compressed digital stream.

13. The method of claim 1, wherein the first content is related to the second content.

14. A method for providing multimedia content from an external device, the method comprising the steps of:
receiving a first signal from a client device and, responsively, sending a response signal indicating a readiness to receive first content, the response signal including performance characteristics of the external device;
receiving the first content from the client device, the first content related to second content presented at a display device, the first content encoded in a digital stream, wherein the step of receiving first content includes receiving synchronization information from the client device, wherein the synchronization information includes at least one of presentation time stamps, decoding time stamps, and embedded synchronization instructions;
decoding the digital stream to produce decoded first content; and
presenting the decoded first content in synchronization with the presentation of the second content at the display device, wherein the first content and the decoded first content includes at least one of audio samples, video samples, and text.

15. A method for providing multimedia content from an external device, the method comprising the steps of:
receiving first content from a client device, the first content related to second content presented at a display device; and
presenting the first content at a time after the presentation of the second content at the display device.

16. The method of claim 15, further including the steps of receiving a first signal from the client device and, responsively, sending a response signal indicating a readiness to receive the first content.

17. The method of claim 15, further including the step of, responsive to being activated, sending a signal to the client device, the signal indicating a readiness to receive the first content.

18. The method of claim 15, further including the step of sending a signal to the client device, the signal including performance characteristics of the external device.

19. The method of claim 15, wherein the step of receiving first content from a client device includes the step of receiving embedded instructions specifying that the presentation of the first content occur in response to at least one of environmental stimuli, an elapsed time, a defined time, and user activation.

20. The method of claim 15, wherein the step of receiving first content from a client device includes the step of receiving embedded instructions specifying that the presentation of the first content occur at any time after the presentation of the second content.

21. The method of claim 15, wherein the first content includes at least one of audio samples, video samples, and text.

22. The method of claim 15, wherein the first content includes at least one of audio samples that are the verbatim audio spoken by a character on a television show presented at the display device, the verbatim audio corresponding to the second content, educational material related to a television education show corresponding to the second content presented at the display device, game content for a game with corresponding characters presented in a television show presented at the display device, the game content including enhanced features for the game, merchandising offers, advertisements, calendars, schedules, dates, descriptive audio that enhances the viewing experience for a physically disabled person, closed captioning that enhances the viewing experience for a physically disabled person, and other information that enhances the viewing experience for a physically disabled person.

23. The method of claim 15, wherein the first content is related to the second content by theme.

24. The method of claim 15, wherein the step of receiving the first content includes the step of receiving the first content using at least one of a two-way radio frequency communication, one-way radio frequency communication, two-way infrared communication, one-way infrared communication, and wired communication.

25. The method of claim 15, further including the step of sending feedback information to the client device to be communicated to a program provider, wherein the feedback information includes at least one of user information, tests to be evaluated, contest registrations, and purchase orders.

26. The method of claim 15, further including the steps of detecting the absence of synchronization information from the client device, and in response to the detection, presenting the first content non-synchronously with the presentation of the second content.

27. The method of claim 15, wherein the step of presenting includes at least one of the steps of presenting the first content at a time after the beginning of the presentation of the second content and presenting the first content after the completion of the presentation of the second content.

28. A method for providing multimedia content from an external device, the method comprising the steps of:
receiving a first signal from a client device and, responsively, sending a response signal indicating a readiness to receive first content, the response signal including performance characteristics of the external device;
receiving the first content from a client device, the first content related to second content presented at a display device, wherein the step of receiving first content includes receiving embedded instructions specifying that the presentation of the first content occur in response to at least one of environmental stimuli, an elapsed time, a defined time, and user activation, wherein the first content includes at least one of audio samples, video samples, and text; and
presenting the first content at a time after the presentation of the second content at the display device.

29. An apparatus for providing multimedia content, the apparatus comprising:
a memory with logic; and
a processor configured with the logic to receive first content from a client device, the first content encoded in a digital stream, wherein the processor is further configured with the logic to decode the digital stream to produce decoded first content, wherein the processor is further configured with the logic to present the decoded first content in synchronization with the presentation of second content presented at a display device.

30. The apparatus of claim 29, further including a transceiver that receives a first signal from the client device and, responsively, sends a response signal that includes information indicating a readiness to receive the first content.

31. The apparatus of claim 29, further including a transceiver that, responsive to being activated, sends a signal to the client device, the signal including information that indicates a readiness to receive the first content.

32. The apparatus of claim 29, further including a transceiver that sends a signal to the client device, the signal including performance characteristics of the apparatus.

33. The apparatus of claim 29, wherein the processor is further configured with the logic to receive synchronization information from the client device, wherein the synchronization information includes at least one of presentation time stamps, decoding time stamps, and embedded synchronization instructions that are used to synchronize the presentation of the decoded first content at the apparatus with the presentation of the second content at the display device.

34. The apparatus of claim 29, wherein the first content and the decoded first content includes at least one of audio samples, video samples, and text.

35. The apparatus of claim 29, wherein the first content and the decoded first content includes at least one of audio samples that are the verbatim audio spoken by a character on a television show presented at the display device, the verbatim audio corresponding to the second content, educational material related to a television education show corresponding to the second content presented at the display device, game content for a game with corresponding characters presented in a television show presented at the display device, the game content including enhanced features for the game, merchandising offers, advertisements, calendars, schedules, dates, descriptive audio that enhances the viewing experience for a physically disabled person, closed captioning that enhances the viewing experience for a physically disabled person, and other information that enhances the viewing experience for a physically disabled person.

36. The apparatus of claim 29, wherein the first content and the decoded first content are related to the second content by theme.

37. The apparatus of claim 29, further including a transceiver configured to operate using at least one of a two-way radio frequency communication and two-way infrared communication.

38. The apparatus of claim 37, wherein the transceiver communicates over a local area network.

39. The apparatus of claim 29, further including a receiver configured to receive using at least one of one-way radio frequency communication and one-way infrared communication.

40. The apparatus of claim 29, further including a communication port configured to receive wired communication.

41. The apparatus of claim 29, wherein the processor is further configured with the logic to send feedback information to the client device to be communicated to a program provider, wherein the feedback information includes at least one of user information, tests to be evaluated, contest registrations, and purchase orders.

42. The apparatus of claim 29, wherein the processor is further configured with the logic to receive synch packets from the client device, the synch packets including presentation time stamps, wherein the processor is further configured with the logic to measure the inter-arrival times of the synch packets, wherein the processor is further configured with the logic to use the measurement to match a clock rate of the client device to an internal clock rate of the apparatus.

43. The apparatus of claim 29, further including at least one of an audio decoder, a video decoder, a battery, actuators, sensors, graphics cards, lighting devices, and memory cards.

44. The apparatus of claim 29, wherein the processor is further configured with the logic to receive and decode a digital stream that is a compressed digital stream.

45. The apparatus of claim 29, wherein the first content is related to the second content.

46. An apparatus for providing multimedia content, the apparatus comprising:
a transceiver that receives a first signal from a client device and, responsively, sends a response signal that includes information indicating a readiness to receive first content from the client device, wherein the first content includes at least one of audio samples, video samples, and text;
a memory with logic; and
a processor configured with the logic to receive the first content from the client device, the first content related to second content presented at a display device, the first content encoded in a digital stream, wherein the processor is further configured with the logic to receive synchronization information from the client device, wherein the synchronization information includes at least one of presentation time stamps, decoding time stamps, and embedded synchronization instructions, wherein the processor is further configured with the logic to decode the digital stream to produce decoded first content, wherein the processor is further configured with the logic to present the decoded first content in synchronization with the presentation of the second content at the display device, wherein the first content and the decoded first content includes at least one of audio samples, video samples, and text.

47. An apparatus for providing multimedia content, the apparatus comprising:
a memory with logic; and
a processor configured with the logic to receive first content from a client device, the first content related to second content presented at a display device, wherein the processor is further configured with the logic to present the first content at a time after the presentation of the second content at the display device.

48. The apparatus of claim 47, further including a transceiver that receives a first signal from the client device and, responsively, sends a response signal that includes information indicating a readiness to receive the first content.

49. The apparatus of claim 47, further including a transceiver that, responsive to the apparatus being activated, sends a signal to the client device, the signal including information that indicates a readiness to receive the first content.

50. The apparatus of claim 47, further including a transceiver that sends a signal to the client device, the signal including performance characteristics of the apparatus.

51. The apparatus of claim 47, wherein the processor is further configured with the logic to receive embedded instructions specifying that the presentation of the first content occur in response to at least one of environmental stimuli, an elapsed time, a defined time, and user activation.

52. The apparatus of claim 47, wherein the processor is further configured with the logic to receive embedded instructions specifying that the presentation of the first content occur at anytime after the presentation of the second content.

53. The apparatus of claim 47, wherein the first content includes at least one of audio samples, video samples, and text.

54. The apparatus of claim 47, wherein the first content includes at least one of audio samples that are the verbatim audio spoken by a character on a television show presented at the display device, the verbatim audio corresponding to the second content, educational material related to a television education show corresponding to the second content presented at the display device, game content for a game with corresponding characters presented in a television show presented at the display device, the game content including enhanced features for the game, merchandising offers, advertisements, calendars, schedules, dates, descriptive audio that enhances the viewing experience for a physically disabled person, closed captioning that enhances the viewing experience for a physically disabled person, and other information that enhances the viewing experience for a physically disabled person.

55. The apparatus of claim 47, wherein the first content is related to the second content by theme.

56. The apparatus of claim 47, further including a transceiver configured to operate using at least one of a two-way radio frequency communication and two-way infrared communication.

57. The apparatus of claim 56, wherein the transceiver communicates over a local area network.

58. The apparatus of claim 47, further including a receiver configured to receive using at least one of one-way radio frequency communication and one-way infrared communication.

59. The apparatus of claim 47, further including a communication port configured to receive wired communication.

60. The apparatus of claim 47, wherein the processor is further configured with the logic to send feedback information to the client device to be communicated to a program provider, wherein the feedback information includes at least one of user information, tests to be evaluated, contest registrations, and purchase orders.

61. The apparatus of claim 47, wherein the processor is further configured with the logic to detect the absence of synchronization information in a signal sent from the client device, and in response to the detection, present the first content non-synchronously with the presentation of the second content.

62. The apparatus of claim 47, further including at least one of an audio decoder, a video decoder, a battery, actuators, sensors, graphics cards, lighting devices, and memory cards.

63. The apparatus of claim 47, wherein the processor is further configured with the logic to present the first content at a time that includes at least one of after the beginning of the presentation of the second content and after the completion of the presentation of the second content.

64. An apparatus for providing multimedia content, the apparatus comprising:
a transceiver that receives a first signal from a client device and, responsively, sends a response signal that includes information indicating a readiness to receive first content from the client device, wherein the first content includes at least one of audio samples, video samples, and text;
a memory with logic; and
a processor configured with the logic to receive first content from the client device, the first content related to second content presented at a display device, wherein the processor is further configured with the logic to receive embedded instructions specifying that the presentation of the first content occur in response to at least one of environmental stimuli, an elapsed time, a defined time, and user activation, wherein the processor is further configured with the logic to present the first content at a time after the presentation of the second content at the display device.
